(19) United States
(12) Patent Application Publication
(10) Pub. No.: US 2023/0132305 A1
(43) Pub. Date: Apr. 27, 2023

(54) PRESSURE-SENSITIVE ADHESIVE SHEET

(71) Applicant: NITTO DENKO CORPORATION, Osaka (JP)

(72) Inventors: Masataka NISHIWAKI, Osaka (JP); Kazuki MINOURA, Osaka (JP); Yasushi BUZOJIMA, Osaka (JP)

(73) Assignee: NITTO DENKO CORPORATION, Osaka (JP)

(21) Appl. No.: 17/912,590

(22) PCT Filed: Mar. 17, 2021
(86) PCT No.: PCT/JP2021/010953

§ 371 Date: Sep. 19, 2022

(30) Foreign Application Priority Data
Mar. 24, 2020 (JP) 2020-052937

(51) Int. Cl. C09J 133/08; C09J 7/38; C09J 11/06; C08F 220/06; C08F 220/18; C08K 5/00

(52) U.S. Cl. CPC C09J 133/08; C09J 7/385; C09J 11/06; C08F 220/06; C08F 220/1804; C08K 5/0041; C09J 2301/122; C09J 2301/124; C09J 2301/302; C09J 2301/408; C08K 2201/003; C08K 2201/011

(57) ABSTRACT

The present invention relates to a pressure-sensitive adhesive sheet including a pressure-sensitive adhesive layer containing a base polymer and a pigment, the pressure-sensitive adhesive sheet having a transmittance for light having wavelengths of 380-600 nm of 25% or less, transmittance for light having wavelengths 800-2,500 nm of 60% or greater, and a change in light transmittance in the wavelength range of 600 to 800 nm of 0.1%/nm or greater.

### TECHNICAL FIELD

The present invention relates to a pressure-sensitive adhesive sheet and particularly, to an infrared-transmitting pressure-sensitive adhesive sheet.

### BACKGROUND ART

In general, a pressure-sensitive adhesive (sometimes referred to as PSA; hereinafter the same) has a property of presenting a soft solid (viscoelastic body) state in a temperature range around room temperature and easily adhering to an adherend with pressure applied.

Taking advantage of such a property, the pressure-sensitive adhesive is widely used for the purpose of, e.g., joining, fixing, or protecting a member in a mobile electronic device such as mobile phone.

For example, in a mobile electronic device, a pressure-sensitive adhesive sheet having a light-blocking property is used for the purpose of, e.g., preventing light leakage from a light source in a backlight module, etc. The document related to this kind of technology includes Patent Literatures 1 to 6.

Patent Literatures 1 to 5 each discloses a pressure-sensitive adhesive sheet in which a black printed layer is provided on one surface of a resin film substrate. Patent Literature 6 is a conventional art document disclosing a single-sided adhesive sheet that is laminated on a graphite sheet.

### CITATION LIST

### Patent Literature

Patent Literature 1: JP-A-2013-87246
Patent Literature 2: JP-A-2013-166891
Patent Literature 3: JP-A-2015-83660
Patent Literature 4: JP-A-2017-57375
Patent Literature 5: JP-A-2018-2898
Patent Literature 6: JP-A-2017-52835

### SUMMARY OF INVENTION

### Technical Problem

The conventional pressure-sensitive adhesive sheet having a light-blocking property blocks infrared light as well as visible light. This involves a problem that in the case of using the pressure-sensitive adhesive sheet in a sensing device, etc. emitting infrared light, since infrared light is also blocked, the object is not irradiated with infrared light and the intended effect is not obtained.

In addition, at the time of inspecting the smoothness of the pressure-sensitive adhesive sheet, the sheet surface is irradiated with infrared light by AOI (automated optical inspection). Therefore, there is also a problem that the infrared light is blocked and the inspection cannot be performed.

Furthermore, there is another problem that the visible range in which the conventional pressure-sensitive adhesive sheet having a light blocking property can block light is narrow.

Then, the present invention has been made to solve those problems in conventional techniques and aims at providing a pressure-sensitive adhesive sheet having wavelength selectivity of blocking light in a wide visible range and transmitting infrared light.

### Solution to Problem

As a result of many intensive studies to attain the object above, the present inventors have found that a pressure-sensitive adhesive sheet having wavelength selectivity of blocking light in a wide visible range and transmitting infrared light is obtained by adjusting the type, content, etc. of the pigment contained in the pressure-sensitive adhesive layer. The present invention has been accomplished based on this finding.

That is, the present invention is as follows.

[1] A pressure-sensitive adhesive sheet including a pressure-sensitive adhesive layer containing a base polymer and a pigment, wherein

the light transmittance in the wavelength range of 380 to 600 nm is 25% or less, the light transmittance in the wavelength range of 800 to 2,500 nm is 60% or more, and

the light transmittance change amount in the wavelength region of 600 to 800 nm, represented by the following formula, is 0.1%/nm or more:

light transmittance change amount (%/nm)=(light transmittance at wavelength of 800 nm−light transmittance at wavelength of 600 nm)/200.

[2] The pressure-sensitive adhesive sheet according to [1], wherein the average particle diameter of the pigment is 250 nm or less.

[3] The pressure-sensitive adhesive sheet according to [1] or [2], wherein the pressure-sensitive adhesive layer contains an acrylic polymer as the base polymer.

[4] The pressure-sensitive adhesive sheet according to any one of [1] to [3], wherein the pressure-sensitive adhesive layer contains from 0.5 to 20 parts by mass of the pigment per 100 parts by mass of the base polymer.

[5] The pressure-sensitive adhesive sheet according to any one of [1] to [4], wherein the thickness is from 10 to 200 μm.

[6] The pressure-sensitive adhesive sheet according to any one of [1] to [5], wherein the 180° peel adhesion (N/25 mm) to an SUS304BA plate is 3 N/25 mm or more.

[7] The pressure-sensitive adhesive sheet according to any one of [1] to [6], which has a substrate.

[8] The pressure-sensitive adhesive sheet according to any one of [1] to [6], which does not have a substrate.

[9] The pressure-sensitive adhesive sheet according to any one of [1] to [8], which is used in an electronic device including a pressure-sensitive sensor.

[10] The pressure-sensitive adhesive sheet according to [9], which is used in a mobile electronic device including a pressure-sensitive sensor to fix the pressure-sensitive sensor to other members.

[11] A mobile electronic device, wherein the pressure-sensitive adhesive sheet according to any one of [1] to [10] is used.

### Advantageous Effects of Invention

According to the present invention, a pressure-sensitive adhesive sheet having wavelength selectivity of blocking light in a wide visible range and transmitting infrared light can be provided.

### BRIEF DESCRIPTION OF DRAWINGS

FIG. 1 is one example of the schematic cross-sectional diagram of the pressure-sensitive adhesive sheet (pressure-sensitive adhesive layer) according to an embodiment of the present invention.

FIG. 2 is one example of the schematic cross-sectional diagram of the pressure-sensitive adhesive sheet according to an embodiment of the present invention.

FIG. 3 is one example of the schematic cross-sectional diagram of the pressure-sensitive adhesive sheet according to an embodiment of the present invention.

FIG. 4 is a graph illustrating the light transmittance change in pressure-sensitive adhesive sheets of Examples and Comparative Examples.

### DESCRIPTION OF EMBODIMENTS

The present invention is described in detail below by referring to the appended drawings, but the present invention is not limited to the following embodiments and can be implemented by arbitrarily making modifications therein without departing from the gist of the present invention. In addition, numerical value ranges represented using “to” mean that the range includes numerical values described before and after “to” as a lower limit value and an upper limit value, respectively.

In the present description, the “pressure-sensitive adhesive” refers to a material having a property of presenting a soft solid (viscoelastic body) state in a temperature range around room temperature and easily adhering to an adherend with pressure applied. As defined in “C. A. Dahlquist, “Adhesion: Fundamental and Practice”, McLaren & Sons (1966), P. 143”, the pressure-sensitive adhesive as used herein can generally be a material having the property satisfying complex tensile modulus E* (1 Hz)<107 dyne/cm² (typically, a material having the above property at 25° C.).

Also, in the present description, unless specified otherwise, the “main component” indicates a component contained in an amount in excess of 50 mass %.

Furthermore, in the present description, the percentage, etc. based on the mass have the same meanings as the percentage, etc. based on the weight.

The pressure-sensitive adhesive sheet in an embodiment of the present invention (hereinafter, sometimes simply referred to as the pressure-sensitive adhesive sheet) includes a pressure-sensitive adhesive layer containing a base polymer and a pigment (hereinafter, sometimes simply referred to as a pressure-sensitive adhesive layer) and is characterized in that the light transmittance in the wavelength range of 380 to 600 nm is 25% or less, the light transmittance in the wavelength range of 800 to 2,500 nm is 60% or more, and the light transmittance change amount in the wavelength region of 600 to 800 nm, represented by the following formula, is 0.1%/nm or more:

light transmittance change amount (%/nm)=(light transmittance at wavelength of 800 nm−light transmittance at wavelength of 600 nm)/200.

### <Light Transmittance>

In the pressure-sensitive adhesive sheet of this embodiment, the light transmittance in the wavelength range of 380 to 600 nm is 25% or less, and the light transmittance in the wavelength range of 800 to 2,500 nm is 60% or more.

Here, the light transmittance in the wavelength range of 380 to 600 nm being 25% or less means that over the entire wavelength range of 380 to 600 nm, the light transmittance is 25% or less.

Also, the light transmittance in the wavelength range of 800 to 2,500 nm being 60% or more means that over the entire wavelength range of 800 to 2,500 nm, the light transmittance is 60% or more.

The wavelength of 380 to 600 nm corresponds to a part of the visible range. When the light transmittance in the wavelength range of 380 to 600 nm is 25% or less, transmission of visible light can be sufficiently reduced. The light transmittance in the wavelength range of 380 to 600 nm is preferably 20% or less, more preferably 15% or less, still more preferably 10% or less.

The wavelength of 800 to 2,500 nm corresponds to a part of the infrared range. When the light transmittance in the wavelength range of 800 to 2,500 nm is 60% or more, infrared light can be sufficiently transmitted. The light transmittance in the wavelength range of 800 to 2,500 nm is preferably 65% or more, more preferably 70% or more, still more preferably 75% or more.

Setting of the light transmittance at the specific wavelength above to the specific range above can be realized by adjusting the type, content, etc. of a pigment that is one component of the later-described pressure-sensitive adhesive layer. Specifically, pigments have various colors such as red, yellow, green, blue and violet and exhibit respective particular light transmittance behaviors. Setting can be realized by, from these various pigments exhibiting a variety of light transmittance behaviors, selecting a pigment having the predetermined light transmittance above, combining two or more pigments, or furthermore, adjusting the contents or content ratio of various pigments.

Incidentally, as for the light transmittance behavior, the pigment exhibits the same behavior even in the state of being contained in the pressure-sensitive adhesive layer.

The light transmittance in the pressure-sensitive adhesive sheet of this embodiment can be determined by measuring the absorption spectrum by means of a spectrophotometer. For example, the light transmittance can be measured by using Spectrophotometer Model U-4100 (manufactured by Hitachi High-Technologies Corporation) and setting the measurement wavelength to a range of 380 to 2,500 nm.

### <Light Transmittance Change Amount>

In the pressure-sensitive adhesive sheet of this embodiment, the light transmittance change amount in the wavelength region of 600 to 800 nm, represented by the following formula, is 0.1%/nm or more:

light transmittance change amount (%/nm)=(light transmittance at wavelength of 800 nm−light transmittance at wavelength of 600 nm)/200.

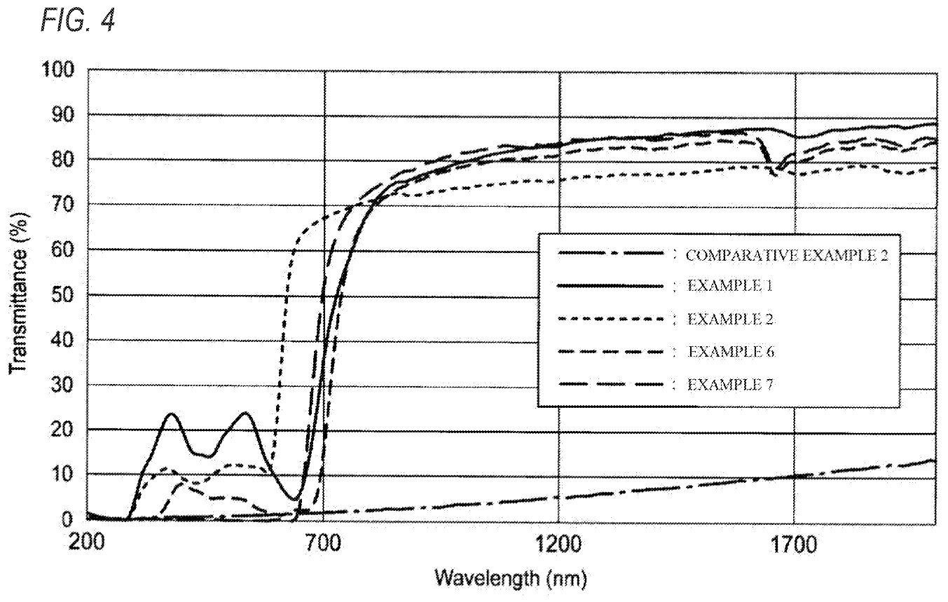

The wavelength region of 600 to 800 nm corresponds to a visible range close to the infrared range. In the case of blocking light in a wide visible range and transmitting infrared light, as illustrated in Examples (FIG. 4), within the visible range (wavelength region of 600 to 800 nm) close to the infrared range, the light transmittance is low below a certain wavelength, but the light transmittance begins to increase at a certain wavelength, and the pressure-sensitive adhesive sheet comes to have high light transmittance. That is, the light transmittance change amount per 1 nm of wavelength in the above-described visible range (wavelength region of 600 to 800 nm) close to the infrared range is not less than a certain value.

In the pressure-sensitive adhesive sheet of this embodiment, the light transmittance change amount in the wavelength region of 600 to 800 nm is set to 0.1%/nm or more, and this makes is possible to block light in a wide visible range and transmit infrared light.

The light transmittance change amount in the wavelength region of 600 to 800 nm is preferably 0.1%/nm or more, more preferably 0.2%/nm or more.

Also, in the pressure-sensitive adhesive sheet of this embodiment, it is more preferred that the light transmittance change amount in the wavelength region of 650 to 750 nm is 0.1%/nm or more. In this case, the wavelength selectivity between visible light and infrared light is more improved.

The light transmittance change amount in the wavelength region of 650 to 750 nm is preferably 0.2%/nm or more, more preferably 0.5%/nm or more, still more preferably 1.0%/nm or more.

The pressure-sensitive adhesive layer constituting the pressure-sensitive adhesive sheet of this embodiment is described below.

### <Pressure-Sensitive Adhesive Layer>

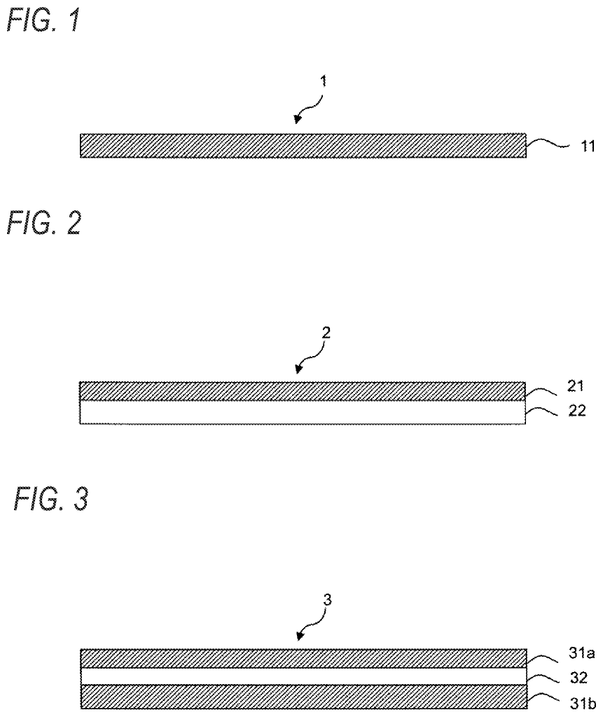

The pressure-sensitive adhesive layer of this embodiment contains a base polymer and a pigment. FIG. 1 is a schematic cross-sectional diagram illustrating one configuration example of the pressure-sensitive adhesive layer according to one embodiment of the present invention. In FIG. 1, a pressure-sensitive adhesive layer having a single layer structure is illustrated, but the pressure-sensitive adhesive layer may have a multilayer structure of two or more layers.

Each component contained in the pressure-sensitive adhesive layer or the pressure-sensitive adhesive composition for forming the pressure-sensitive adhesive layer is described below.

### <Base Polymer>

The “base polymer” in this embodiment refers to a main component of a rubber-like polymer contained in the pressure-sensitive adhesive. The rubber-like polymer refers to a polymer that exhibits rubber elasticity in the temperature range around room temperature.

In this embodiment, the type of the base polymer is not particularly limited, and those known in the field of pressure-sensitive adhesives can be used. The pressure-sensitive adhesive layer may be, for example, a layer containing, as the base polymer, one polymer or two or more polymers among various rubber-like polymers such as acrylic polymer, rubber-based polymer, polyester-based polymer, urethane-based polymer, polyether-based polymer, silicone-based polymer, polyamide-based polymer and fluoropolymer.

In view of the pressure-sensitive adhesive performance, cost, etc., it is preferable to contain an acrylic polymer or rubber-based polymer as the base polymer. Among others, in view of dispersibility of the later-described pigment, it is more preferable to use an acrylic polymer as the base polymer.

In the following, a pressure-sensitive adhesive layer containing an acrylic polymer as the base polymer is mainly described, but this is not intended to limit the pressure-sensitive adhesive layer in this embodiment to a layer constituted by an acrylic polymer.

The “acrylic polymer” refers to a polymerized product including, as the monomer unit constituting the polymer, a monomer unit derived from a monomer having at least one (meth)acryloyl group per molecule. Hereinafter, a monomer having at least one (meth)acryloyl group per molecule is referred to as an “acrylic monomer”. Accordingly, the acrylic polymer as used in the present description is defined as a polymer including a monomer unit derived from an acrylic monomer. Typical examples of the acrylic polymer include an acrylic polymer in which the proportion of the acrylic monomer is more than 50 mass % of all monomer components used in the synthesis of the acrylic polymer.

Also, the “(meth)acryloyl” is meant to inclusively indicate acryloyl and methacryloyl. Likewise, the “(meth)acrylate” and “(meth)acryl” are meant, respectively, to inclusively indicate acrylate and methacrylate and inclusively indicate acryl and methacryl.

The acrylic polymer is preferably, for example, a polymerized product of a monomer raw material which includes an alkyl (meth)acrylate as the primary monomer and may further include a secondary monomer having copolymerizability with the primary monomer. Here, the primary monomer refers to a component that accounts for more than 50 mass % of the monomer composition in the monomer raw material.

As the alkyl (meth)acrylate, for example, a compound represented by the following formula (1) may be suitably used:

CH₂═C(R¹)COOR² (1)

Here, in formula (1), R¹ represents a hydrogen atom or a methyl group, and R² represents a chain alkyl group having from 1 to 20 carbon atoms. Hereinafter, such a range of the number of carbon atoms is sometimes designated as “C₁₋₂₀”.

In view of storage modulus, etc. of the pressure-sensitive adhesive, the primary monomer is suitably an alkyl (meth)acrylate in which R² is a C₁₋₁₄ (for example, C₂₋₁₀, typically C₄₋₈) chain alkyl group. In view of pressure-sensitive adhesive properties, the primary monomer is preferably an alkyl acrylate in which R¹ is a hydrogen atom and R² is a C₄₋₈ chain alkyl group (hereinafter, sometimes simply referred to as a C₄₋₈ alkyl acrylate).

The alkyl (meth)acrylate in which R² is a C₁₋₂₀ chain alkyl group includes, for example, methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, etc.

One of these alkyl (meth)acrylates may be used alone, or two or more thereof may be used in combination. Preferable alkyl (meth)acrylates include n-butyl acrylate (BA) and 2-ethylhexyl acrylate (2EHA).

The proportion of the alkyl (meth)acrylate to monomer components constituting the acrylic polymer is typically more than 50 mass % and may be, for example, 70 mass % or more, may be 85 mass % or more, or may be 90 mass % or more. Also, the proportion of the alkyl (meth)acrylate to the monomer components is typically less than 100 mass % and in view of cohesive force, etc., is usually, suitably 99.5 mass % or less, may be 98 mass % or less, or may be less than 97 mass %.

This embodiment can be preferably implemented in a mode where the monomer components contain 50 mass % or more of a C₁₋₄ alkyl (meth)acrylate. The proportion of the C₁₋₄ alkyl (meth)acrylate to monomer components may be 70 mass % or more, may be 85 mass % or more, or may be 90 mass % or more.

On the other hand, in view of cohesive force, etc., the proportion of the C₁₋₄ alkyl (meth)acrylate to monomer components is, usually, suitably 99.5 mass % or less, may be 98 mass % or less, or may be less than 97 mass %.

In this embodiment, the monomer components may contain 50 mass % or more, 70 mass % or more, 85 mass % or more, or 90 mass % or more, of a C₂₋₄ alkyl acrylate.

Specific examples of the C₂₋₄ alkyl acrylate include ethyl acrylate, propyl acrylate, isopropyl acrylate, n-butyl acrylate (BA), isobutyl acrylate, s-butyl acrylate and tert-butyl acrylate. As for the C₂₋₄ alkyl acrylate, one may be used alone, or two or more may be used in combination. According to such a mode, a pressure-sensitive adhesive sheet exhibiting good adhesiveness to an adherend is likely to be realized.

Among others, in one preferred aspect, the monomer components may contain more than 50 mass %, 70 mass % or more, 85 mass % or more, or 90 mass % or more, of BA. By using the C₂₋₄ alkyl acrylate (for example, BA) in not less than the predetermined amount, even when the later-described pigment is blended in the pressure-sensitive adhesive layer, the pressure-sensitive adhesive properties such as adhesive strength can be successfully maintained while well dispersing the pigment in the layer.

On the other hand, from the viewpoint of obtaining good cohesive force, etc., the proportion of the C₁₋₄ alkyl (meth)acrylate to monomer components is, usually, suitably 99.5 mass % or less, may be 98 mass % or less, or may be less than 97 mass %.

In another aspect, the monomer components may contain 50 mass % or more, 70 mass % or more, 85 mass % or more, or 90 mass % or more, of a C₅₋₂₀ alkyl (meth)acrylate.

The C₅₋₂₀ alkyl (meth)acrylate is preferably a C₆₋₁₄ alkyl (meth)acrylate. In one aspect, a C₆₋₁₀ alkyl acrylate or a C₈₋₁₀ alkyl acrylate may be preferably employed.

In this embodiment, the monomer components constituting the base polymer (for example, acrylic polymer) may contain a carboxy group-containing monomer. When the monomer components contain a carboxy group-containing monomer, a pressure-sensitive adhesive layer exhibiting good durability against impact in the shear direction is likely to be obtained. In addition, the inclusion of the above monomer can also be advantageous in enhancing the adhesiveness between the pressure-sensitive adhesive layer and an adherend.

Examples of the carboxy group-containing monomer include an ethylenically unsaturated monocarboxylic acid such as acrylic acid, methacrylic acid, carboxyethyl (meth)acrylate, carboxypentyl (meth)acrylate, crotonic acid and isocrotonic acid; an ethylenically unsaturated dicarboxylic acid such as maleic acid, itaconic acid and citraconic acid, and their anhydrides (e.g., maleic anhydride, itaconic anhydride). Any one of these may be used alone, or two members thereof may be used in combination. Among these, preferable carboxy group-containing monomers include acrylic acid (AA) and methacrylic acid (MAA), with AA being more preferred.

In a mode where a carboxy group-containing monomer is copolymerized in the base polymer, the content of the carboxy group-containing monomer in the monomer components constituting the base polymer is not particularly limited. For example, the content may be 0.2 mass % or more (typically 0.5 mass % or more) of the monomer components, usually, is suitably 1 mass % or more, may be 2 mass % or more, or may be 3 mass % or more.

When the content of the carboxy group-containing monomer is set to 3 mass % or more, a higher effect is exhibited, and a pressure-sensitive adhesive layer having more excellent holding performance is obtained. From such a viewpoint, in one preferred aspect, the content of the carboxy group-containing monomer may be 3.2 mass % or more, preferably 3.5 mass % or more, more preferably 4 mass % or more, and even 4.5 mass % or more, of the monomer components. By copolymerizing the carboxy group-containing monomer in such an amount, even when the later-described pigment is blended in the pressure-sensitive adhesive layer, the pressure-sensitive adhesive properties such as shear holding power can be successfully realized while well dispersing the pigment in the layer.

The upper limit of the content of the carboxy group-containing monomer is not particularly limited and, for example, may be 15 mass % or less, may be 12 mass % or less, or may be 10 mass % or less. By limiting the copolymerization ratio of the carboxy group-containing monomer to not more than the predetermined amount, even when the later-described pigment is blended in the pressure-sensitive adhesive layer, the pressure-sensitive adhesive properties such as adhesive strength can be successfully maintained while well dispersing the pigment in the layer.

In this embodiment, the content of the carboxy group-containing monomer may be 7 mass % or less, may be less than 7 mass %, may be 6.8 mass % or less, or may be 6.0 mass % or less, of the monomer components.

The secondary monomer having copolymerizability with the alkyl (meth)acrylate as the primary monomer can be useful in introducing a crosslinking point into the acrylic polymer or increasing the cohesive force of the acrylic polymer.

As the secondary monomer, for example, one of the following functional group-containing monomers (excluding the above-described carboxy group-containing monomer) may be used alone, or two or more thereof may be used in combination.

Hydroxy group-containing monomers: for example, hydroxyalkyl (meth)acrylates such as 2-hydroxyethyl (meth)acrylate, 2-hydroxypropyl (meth)acrylate, 3-hydroxypropyl (meth)acrylate and 4-hydroxybutyl (meth)acrylate; unsaturated alcohols such as vinyl alcohol and allyl alcohol; and polypropylene glycol mono(meth)acrylate.

Amide group-containing monomers: for example, (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide, and N-butoxymethyl (meth)acrylamide.

Amino group-containing monomers: for example, aminoethyl (meth)acrylate, N,N-dimethylaminoethyl (meth)acrylate, and tert-butylaminoethyl (meth)acrylate.

Monomers having an epoxy group: for example, glycidyl (meth)acrylate, methylglycidyl (meth)acrylate, and allyl glycidyl ether.

Cyano group-containing monomers: for example, acrylonitrile and methacrylonitrile.

Keto group-containing monomers: for example, diacetone (meth)acrylamide, diacetone (meth)acrylate, vinyl methyl ketone, vinyl ethyl ketone, allyl acetoacetate, and vinyl acetoacetate.

Monomers having a nitrogen atom-containing ring: for example, N-vinyl pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, and N-(meth)acryloylmorpholine.

Alkoxysilyl group-containing monomers: for example, 3-(meth)acryloxypropyltrimethoxysilane, 3-(meth)acryloxypropyltriethoxysilane, 3-(meth)acryloxypropylmethyldimethoxysilane, and 3-(meth)acryloxypropylmethyldiethoxysilane.

In the case where the monomer components constituting the acrylic polymer contain the above-described functional group-containing monomer, the content of the functional group-containing monomer in the monomer components is not particularly limited.

From the viewpoint of appropriately exhibiting the effect due to using the functional group-containing monomer, the content of the functional group-containing monomer in the monomer components may be, for example, 0.1 mass % or more, is, usually, suitably 0.5 mass % or more, or may be 1 mass % or more.

From the viewpoint of easily balancing the pressure-sensitive adhesive performance relative to the primary monomer or the carboxy group-containing monomer, the content of the functional group-containing monomer in the monomer components is, usually, suitably 40 mass % or less, is preferably 20 mass % or less, may be 10 mass % or less, or may be 5 mass % or less.

The technique disclosed herein may also be preferably implemented in a mode where the monomer components are substantially free from the functional group-containing monomer. For example, the technique can also be preferably implemented in a mode where the monomer components are substantially composed of only the alkyl (meth)acrylate and the carboxy group-containing monomer.

Here, the monomer components being substantially free from the functional group-containing monomer indicates that the functional group-containing monomer is not used at least intentionally. For example, it is allowable to unintentionally contain 0.05 mass % or less or 0.01 mass % or less of the functional group-containing monomer. In an acrylic polymer having such a monomer composition, the later-described pigment can readily be dispersed.

For the purpose of, e.g., enhancing the cohesive force, the monomer components constituting the acrylic polymer may contain other copolymerization component besides the secondary monomer.

Examples of the other copolymerization component include a vinyl ester-based monomer such as vinyl acetate, vinyl propionate and vinyl laurate; an aromatic vinyl compound such as styrene, substituted styrene (α-methylstyrene, etc.) and vinyl toluene; a cycloalkyl (meth)acrylate such as cyclohexyl (meth)acrylate, cyclopentyl (meth)acrylate and isobornyl (meth)acrylate; an aromatic ring-containing (meth)acrylate such as aryl (meth)acrylate (e.g. phenyl (meth)acrylate), aryloxyalkyl (meth)acrylate (e.g. phenoxyethyl (meth)acrylate) and arylalkyl (meth)acrylate (e.g. benzyl (meth)acrylate); an olefinic monomer such as ethylene, propylene, isoprene, butadiene and isobutylene; a chlorine-containing monomer such as vinyl chloride and vinylidene chloride; an isocyanate group-containing monomer such as 2-(meth)acryloyloxyethyl isocyanate; an alkoxy group-containing monomer such as methoxyethyl (meth)acrylate and ethoxyethyl (meth)acrylate; a vinyl ether-based monomer such as methyl vinyl ether and ethyl vinyl ether; and a polyfunctional monomer having two or more (e.g. three or more) polymerizable functional groups (e.g. (meth)acryloyl groups) per molecule, such as 1,6-hexanediol di(meth)acrylate and trimethylolpropane tri(meth)acrylate.

The amount of such other copolymerization component may be appropriately selected according to the purpose and usage and is not particularly limited. From the viewpoint of appropriately exhibiting the effect due to its use, the amount is, usually, suitably 0.05 mass % or more and may also be 0.5 mass % or more.

In addition, from the viewpoint of easily balancing the pressure-sensitive adhesive performance, the content of the other copolymerization component in the monomer components is, usually, suitably 20 mass % or less, may be 10 mass % or less, or may be 5 mass % or less. This embodiment may also be preferably implemented in a mode where the monomer components are substantially free from the other copolymerization component.

Here, the monomer components being substantially free from the other copolymerization component indicates that the other copolymerization component is not used at least intentionally, and it is allowable to unintentionally contain, for example, 0.01 mass % or less of the other copolymerization component. In an acrylic polymer having such a monomer composition, the later-described pigment can readily be dispersed.

The copolymerization composition of the acrylic polymer is suitably designed so that the glass transition temperature (Tg) of the polymer becomes−15° C. or less (e.g., −70° C. or more and −15° C. or less). Here, Tg of the acrylic polymer refers to Tg determined using the Fox equation based on the composition of monomer components used in the synthesis of the polymer. The Fox equation is, as shown below, a relational expression of Tg of a copolymer and the glass transition temperature Tgi of a homopolymer obtained by the homopolymerization of each of the monomers constituting the copolymer.

1/Tg=Σ(Wi/Tgi)

Here, in the Fox equation above, Tg represents the glass transition temperature (unit: K) of the copolymer, Wi represents the mass fraction (copolymerization ratio on the mass basis) of a monomer i in the copolymer, and Tgi represents the glass transition temperature (unit: K) of a homopolymer of the monomer i.

As for the glass transition temperature of a homopolymer, which is used for the calculation of Tg, the values disclosed in publicly known resources are used. For example, with respect to the monomers listed below, the following values are used as the glass transition temperatures of homopolymers of the monomers.

| | |
|---|---|
| 2-ethylhexyl acrylate | −70° C. |
| isononyl acrylate | −60° C. |
| n-butyl acrylate | −55° C. |
| ethyl acrylate | −22° C. |
| methyl acrylate | 8° C. |
| methyl methacrylate | 105° C. |
| 2-hydroxyethyl acrylate | −15° C. |
| 4-hydroxybutyl acrylate | −40° C. |
| vinyl acetate | 32° C. |
| acrylic acid | 106° C. |
| methacrylic acid | 228° C. |

With respect to the glass transition temperatures of homopolymers of monomers other than those exemplified above, the values described in “Polymer Handbook” (3rd edition, John Wiley & Sons, Inc., 1989) are used. As to the monomer for which a plurality of kinds of values are described, the highest value is employed. In the case of being not described in the Polymer Handbook, values obtained by the measurement method described in JP-A-2007-51271 are used.

Although not particularly limited, in view of the adhesiveness to an adherend, Tg of the acrylic polymer is advantageously−25° C. or less, preferably −35° C. or less, more preferably −40° C. or less.

In one aspect, in view of cohesive force, Tg of the acrylic polymer may be, for example, −65° C. or more, −60° C. or more, or −55° C. or more. The technique disclosed herein can preferably be implemented in a mode where Tg of the acrylic polymer is −65° C. or more and −35° C. or less, or −55° C. or more and −40° C. or less.

The Tg of the acrylic polymer can be adjusted by appropriately changing the monomer composition (i.e., the types or usage amount ratio of monomers used for synthesizing the polymer).

The method for obtaining the acrylic polymer is not particularly limited, and various polymerization methods known as synthesis techniques for acrylic polymers, such as solution polymerization method, emulsion polymerization method, bulk polymerization method, suspension polymerization method and photopolymerization method, can be appropriately employed. For example, a solution polymerization method may be preferably used. The polymerization temperature at the time of performing the solution polymerization can be appropriately selected according to, e.g., the types of monomer and solvent used or the type of polymerization initiator and may be, for example, from 20° C. to 170° C., typically, from 40° C. to 140° C.

The solvent (polymerization solvent) used in the solution polymerization may be appropriately selected from conventionally known organic solvents. For example, any one solvent or a mixed solvent of two or more, selected from aromatic compounds (typically aromatic hydrocarbons) such as toluene; acetic acid esters such as ethyl acetate; aliphatic or alicyclic hydrocarbons such as hexane and cyclohexane; halogenated alkanes such as 1,2-dichloroethane; lower alcohols (e.g. monohydric alcohols having from 1 to 4 carbon atoms) such as isopropanol; ethers such as tert-butyl methyl ether; ketones such as methyl ethyl ketone; etc., may be used.

The initiator used for the polymerization may be appropriately selected from conventionally known polymerization initiators according to the type of the polymerization method. For example, one of azo-based polymerization initiators such as 2,2′-azobisisobutyronitrile (AIBN), or two or more thereof may be preferably used.

Other examples of the polymerization initiator include a persulfate such as potassium persulfate; a peroxide-based initiator such as benzoyl peroxide and hydrogen peroxide; a substituted ethane-based initiator such as phenyl-substituted ethane; an aromatic carbonyl compound; etc.

Still other examples of the polymerization initiator include a redox type initiator based on a combination of a peroxide and a reducing agent. One of such polymerization initiators may be used alone, or two or more thereof may be used in combination.

The amount used of the polymerization initiator may be sufficient if it is a normal usage amount, and may be selected, for example, from the range of 0.005 to 1 part by mass, typically, from 0.01 to 1 part by mass, per 100 parts by mass of the monomer components.

According to the solution polymerization, a polymerization reaction solution in the form of an acrylic polymer being dissolved in an organic solvent is obtained. The pressure-sensitive adhesive layer in this embodiment may be a layer containing the polymerization reaction solution above or an acrylic polymer solution obtained by subjecting the reaction solution to an appropriate post-processing.

As the acrylic polymer solution above, a solution after adjusting the polymerization reaction solution to an appropriate viscosity (concentration) as needed may be used. Alternatively, an acrylic polymer solution prepared by synthesizing an acrylic polymer by a polymerization method other than solution polymerization, such as emulsion polymerization, photopolymerization, bulk polymerization, etc., and dissolving the acrylic polymer in an organic solvent may also be used.

The mass average molecular weight (Mw) of the base polymer (suitably, an acrylic polymer) in the technique disclosed herein is not particularly limited and may be, for example, from 10×10⁴ to 500×10⁴. In view of the pressure-sensitive adhesive performance, Mw of the base polymer is preferably from 30×10⁴ to 200×10⁴, more preferably from 45×10⁴ to 150×10⁴, typically from 65×10⁴ to 130×10⁴).

By using a base polymer having high Mw, it is likely that higher impact resistance is obtained by making use of the cohesive force of the polymer itself.

Here, Mw refers to a value in terms of standard polystyrene obtained by GPC (gel permeation chromatography). As the GPC apparatus, for example, model name “HLC-8320GPC” (column: TSKgel GMH-H(S), manufactured by Tosoh Corporation) may be used.

### (Pigment)

In this embodiment, it is important to use a pigment so as to impart visible absorption and infrared transmission functions to the pressure-sensitive adhesive layer while maintaining the pressure-sensitive adhesive force of the pressure-sensitive adhesive layer. In the case of using a pigment, there is no concern that the pigment component bleeds out to the pressure-sensitive adhesive surface during promoting environment storage (high-temperature high-humidity storage), and the pressure-sensitive adhesive force as a pressure-sensitive adhesive can be sufficiently exhibited.

The type of the pigment used in this embodiment is selected so that in the pressure-sensitive adhesive sheet of this embodiment, the light transmittance in the wavelength range of 380 to 600 nm becomes 25% or less, the light transmittance in the wavelength range of 800 to 2,500 nm becomes 60% or more, and the light transmittance change amount in the wavelength region of 600 to 800 nm, represented by the following formula, becomes 0.1%/nm or more:

light transmittance change amount (%/nm)=(light transmittance at wavelength of 800 nm−light transmittance at wavelength of 600 nm)/200.

As long as the conditions regarding light transmittances and light transmittance change amount at those specific wavelengths are satisfied, the type of the pigment is not particularly limited, and both an organic pigment and an inorganic pigment can be used.

The organic pigment includes, for example, an azo pigment such as azo lake pigment, insoluble monoazo pigment, insoluble disazo pigment, condensed azo pigment and chelate azo pigment; a polycyclic pigment such as phthalocyanine pigment, perylene pigment, perynone pigment, anthraquinone pigment, quinacridone pigment, dioxazine pigment, thioindigo pigment, isoindolinone pigment and quinophthalone pigment; a chelate such as basic dye chelate and acidic dye chelate; a nitro pigment; a nitroso pigment; etc. These may be used individually or as a mixture of two or more.

The inorganic pigment includes, for example, titanium oxide, iron oxide, red iron oxide, chromium oxide, iron blue, ultramarine, molybdenum red, iron black, chrome yellow, etc. These may be used individually or as a mixture of two or more.

Among others, considering light fastness, an isoindolinone pigment, a quinacridone pigment, a condensed azo pigment, a phthalocyanine pigment, a quinophthalone pigment, and an anthraquinone pigment are suitably used.

Specific examples of the organic pigment include Pigment-Yellow 1 (color index (hereinafter, referred to as C.I.) 11680), Pigment-Yellow 3 (C.I. 11710), Pigment-Yellow 14 (C.I. 21095), Pigment-Yellow 17 (C.I. 21105), Pigment-Yellow 42 (C.I. 77492), Pigment-Yellow 74 (C.I. 11741), Pigment-Yellow 83 (C.I. 21108), Pigment-Yellow 93 (C.I. 20710), Pigment-Yellow 98 (C.I. 11727), Pigment-Yellow 109 (C.I. 56284), Pigment-Yellow 110 (C.I. 56280), Pigment-Yellow 128 (C.I. 20037), Pigment-Yellow 129 (C.I. 48042), Pigment-Yellow 138 (C.I. 56300), Pigment-Yellow 139 (C.I. 56298), Pigment-Yellow 147 (C.I. 60645), Pigment-Yellow 150 (C.I. 12764), Pigment-Yellow 154 (C.I. 11781), Pigment-Yellow 155 (C.I. 200310), Pigment-Yellow 180 (C.I. 21290), Pigment-Yellow 185 (C.I. 56280), Pigment-Yellow 199 (C.I. 653200), Pigment-Orange 5 (C.I. 12075), Pigment-Orange 13 (C.I. 21110), Pigment-Orange 16 (C.I. 21160), Pigment-Orange 34 (C.I. 21160), Pigment-Orange 43 (C.I. 71105), Pigment-Orange 61 (C.I. 11265), Pigment-Orange 71 (C.I. 561200), Pigment-Red 5 (C.I. 12490), Pigment-Red 8 (C.I. 12335), Pigment-Red 17 (C.I. 12390), Pigment-Red 22 (C.I. 12315), Pigment-Red 48:2 (C.I. 15865:2), Pigment-Red 112 (C.I. 12370), Pigment-Red 122 (C.I. 73915), Pigment-Red 170 (C.I. 12475), Pigment-Red 176 (C.I. 12515), Pigment-Red 177 (C.I. 65300), Pigment-Red 178 (C.I. 71155), Pigment-Red 179 (C.I. 71130), Pigment-Red 185 (C.I. 12516), Pigment-Red 202 (C.I. 73907), Pigment-Red 208 (C.I. 12514), Pigment-Red 254 (C.I. 56110), Pigment-Red 255 (C.I. 561050), Pigment-Red 264, Pigment-Red 272 (C.I. 561150), Pigment-Violet 19 (C.I. 73900), Pigment-Violet 23 (C.I. 51319), Pigment-Blue 15:1 (C.I. 74160), Pigment-Blue 15:3 (C.I. 74160), Pigment-Blue 15:4 (C.I. 74160), Pigment-Blue 60 (C.I. 69800), Pigment-Green 7 (C.I. 74260), Pigment-Green 36 (C.I. 74265), etc., and one type or a mixture of two or more types is preferred.

Specific examples of the inorganic pigment include Pigment-Yellow 42 (C.I. 77492), Pigment-White 6 (C.I. 77891), Pigment-Blue 27 (C.I. 77510), Pigment-Blue 29 (C.I. 77007), Pigment-Black 7 (C.I. 77266), etc., and one type or a mixture of two or more types is preferred.

In particular, considering color, coloring power, etc., preferred are Pigment-Yellow 74 (C.I. 11741), Pigment-Yellow 109 (C.I. 56284), Pigment-Yellow 110 (C.I. 56280), Pigment-Yellow 128 (C.I. 20037), Pigment-Yellow 138 (C.I. 56300), Pigment-Yellow 150 (C.I. 12764), Pigment-Yellow 155 (C.I. 200310), Pigment-Yellow 180 (C.I. 21290), Pigment-Green 7 (C.I. 74260), Pigment-Green 36 (C.I. 74265), Pigment-Red 122 (C.I. 73915), Pigment-Red 177 (C.I. 65300), Pigment-Red 202 (C.I. 73907), Pigment-Red 254 (C.I. 56110), Pigment-Violet 19 (C.I. 73900), Pigment-Violet 23 (C.I. 51319), Pigment-Blue 15:1 (C.I. 74160), Pigment-Blue 15:3 (C.I. 74160), Pigment-Blue 15:4 (C.I. 74160), Pigment-Blue 15:6 (C.I. 74160), Pigment-Blue 60 (C.I. 69800), Pigment-Black 7 (C.I. 77266), etc.

The shape of the pigment is not particularly limited and may be, for example, powder, granule, wet cake, or slurry.

Among these, particularly, as the pigment for red color, one or more pigments selected from the group consisting of Pigment-Red 177 (C.I. 65300), Pigment-Red 254 (C.I. 56110), and Pigment-Yellow 150 (C.I. 12764) may be suitably used. Above all, a combination of Pigment-Red 177 (C.I. 65300) and Pigment-Yellow 150 (C.I. 12764) and furthermore, a combination of Pigment-Red 177 (C.I. 65300), Pigment-Red 254 (C.I. 56110) and Pigment-Yellow 150 (C.I. 12764) may be suitably used. By optimizing the mixing ratio thereof, the contrast ratio that is one of color performances can further be enhanced.

The mixing ratio of Pigment-Yellow 150 is preferably from 5 to 40 mass % of the pigment portion, because it is important to match the target chromaticity.

Also, as the ink for green color, one or more pigments selected from the group consisting of Pigment-Green 7 (C.I. 74260), Pigment-Green 36 (C.I. 74265), Pigment-Yellow 138 (C.I. 56300), and Pigment-Yellow 150 (C.I. 12764) may be suitably used.

On the other hand, as the ink for blue color, pigments of Pigment-Blue 15:6 (C.I. 74160) and/or Pigment-Violet 23 (C.I. 51319) may be suitably used.

In this embodiment, the average particle diameter of the pigment may be set so that a pressure-sensitive adhesive sheet satisfying the above-described desired light transmittances and light transmittance change amount can be formed.

From the viewpoint of obtaining the above-described desired light transmittances, the lower limit of the average particle diameter of the pigment may be, for example, 10 nm or more, may be 50 nm or more, or may be 100 nm or more.

Also, the upper limit of the average particle diameter of the pigment is, for example, 500 nm or less, may be 300 nm or less, may be 250 nm or less, or may be 200 nm or less.

From the viewpoint of obtaining the above-described desired light transmittance change amount, the average particle diameter of the pigment is preferably not more than a certain value. Because, when the average particle diameter of the pigment is reduced, light scattering and diffraction are likely to occur. More specifically, although light has a property of being readily diffracted at high wavelength and hardly diffracted at low wavelength, when the average particle diameter of the pigment is reduced, scattering and diffraction of light are likely to occur, and this makes it easy to obtain a light transmittance change according to the wavelength.

In view of the above, the upper limit of the average particle diameter of the pigment is preferably 250 nm or less, more preferably 150 nm or less, still more preferably 130 nm or less.

The average particle diameter of the pigment indicates the volume average particle diameter and specifically, means the particle diameter at a cumulative value of 50% (50% volume average particle diameter; hereinafter, sometimes simply referred to as D₅₀) in the particle size distribution measured by a particle size distribution measuring apparatus based on the laser scattering-diffraction method. As for the measuring apparatus, for example, product name “MICROTRAC MT3000II” manufactured by MicrotracBEL Corp. or its equivalent product can be used.

In this embodiment, the addition form of the pigment to the pressure-sensitive adhesive composition is not particularly limited. For example, the pigment may be added to the pressure-sensitive adhesive composition in the form of a dispersion liquid in the state of the particles being dispersed in a dispersion medium.

The dispersion medium constituting the dispersion liquid is not particularly limited and includes water (ion-exchanged water, reverse osmosis water, distilled water, etc.), various organic solvents (alcohols such as ethanol; ketones such as acetone; ethers such as butyl cellosolve and propylene glycol monomethyl ether acetate; esters such as ethyl acetate; aromatic hydrocarbons such as toluene; and their mixed solvents), and an aqueous mixed solvent of water and the organic solvent above. The dispersion liquid may contain the later-described dispersant. Mixing of the dispersion liquid with the pressure-sensitive adhesive composition enables the pressure-sensitive adhesive composition to contain a pigment and furthermore, contain the later-described dispersant as well.

The blending amount of the pigment is not particularly limited and may be set so that a pressure-sensitive adhesive sheet satisfying the above-described desired light transmittances and light transmittance change amount can be formed. Usually, the blending amount is suitably 0.5 parts by mass or more per 100 parts by mass of the base polymer.

In view of the light blocking property, the blending amount of the pigment is preferably 1.0 parts by mass or more, more preferably 2.0 parts by mass or more, still more preferably 3.0 parts by mass or more, yet still more preferably 4.0 parts by mass or more.

Also, from the viewpoint of suppressing a reduction in the pressure-sensitive adhesive properties, which may occur from the blending of the pigment, the upper limit of the blending amount of the pigment is preferably 20 parts by mass or less, more preferably 10 parts by mass or less, still more preferably 8 parts by mass or less, yet still more preferably 6 parts by mass or less, per 100 parts by mass of the base polymer.

### (Other Components)

### [Dispersibility-Enhancing Component]

The pressure-sensitive adhesive composition forming the pressure-sensitive adhesive layer of this embodiment may contain a component that contributes to enhancement of the dispersibility of the pigment. This dispersibility-enhancing component may be, for example, a polymer, an oligomer, a liquid resin, a surfactant, etc. The dispersibility-enhancing component is preferably dissolved in the pressure-sensitive adhesive composition.

The oligomer may be, for example, a low molecular weight polymerized product of monomer components including one of acrylic monomers exemplified above or two or more thereof. For example, the oligomer may be an acrylic oligomer having Mw of less than 10×10⁴, preferably less than 5×10⁴.

The liquid resin may be, for example, a tackifying resin (typically, rosin-based, terpene-based, hydrocarbon-based or other tackifying resins, e.g., a hydrogenated rosin methyl ester, etc.) having a softening point of 50° C. or less, preferably 40° C. or less.

Such a dispersibility-enhancing component enables to inhibit uneven dispersion of the pigment and in turn, inhibit uneven coloring of the pressure-sensitive adhesive layer. Consequently, a pressure-sensitive adhesive layer and pressure-sensitive adhesive sheet having higher appearance quality can be formed.

The content of the dispersibility-enhancing component is not particularly limited and from the viewpoint of reducing its effect on the pressure-sensitive adhesive properties (for example, lowering of the cohesion), is, usually, suitably 20 mass % or less, preferably 10 mass % or less, more preferably 7 mass % or less, still more preferably 5 mass % or less, of the entire pressure-sensitive adhesive layer.

In one aspect, the content of the dispersibility-enhancing component may be 10 times or less, preferably 5 times or less, more preferably 3 times or less, the mass of the pigment.

On the other hand, from the viewpoint of successfully obtaining the effect of the dispersibility-enhancing component, its content is, usually, suitably 0.2 mass % or more, preferably 0.5 mass % or more, more preferably 1 mass % or more, of the entire pressure-sensitive adhesive layer.

In one aspect, the content of the dispersibility-enhancing component may be 0.2 times or more, preferably 0.5 times or more, more preferably 1 times or more, the mass of the pigment.

### [Tackifying Resin]

A tackifying resin can be contained in the pressure-sensitive adhesive composition forming the pressure-sensitive adhesive layer of this embodiment. This inclusion enables to increase the peel strength of the pressure-sensitive adhesive layer and pressure-sensitive adhesive sheet.

As the tackifying resin, one resin or two or more resins selected from various known tackifying resins such as phenolic tackifying resin, terpene-based tackifying resin, modified terpene-based tackifying resin, rosin-based tackifying resin, hydrocarbon-based tackifying resin, epoxy-based tackifying resin, polyamide-based tackifying resin, elastomer-based tackifying resin and ketone-based tackifying resin, may be used.

Examples of the phenolic tackifying resin include a terpene phenol resin, a hydrogenated terpene phenol resin, an alkylphenol resin, and a rosin phenol resin.

The terpene phenol resin indicates a polymer including a terpene residue and a phenol residue and is a concept encompassing both a copolymer of terpenes and a phenol compound (terpene-phenol copolymer resin) and a phenol-modified homopolymer or copolymer of terpenes (phenol-modified terpene resin). Preferable examples of terpenes constituting such a terpene phenol resin include monoterpenes such as α-pinene, β-pinene and limonene (including d-form, l-form and d/l form (dipentene)).

The hydrogenated terpene phenol resin indicates a hydrogenated terpene phenol resin having a structure resulting from hydrogenation of the terpene phenol resin above. This is sometimes referred to as a hydrogen-added terpene phenol resin.

The alkylphenol resin is a resin (oily phenolic resin) obtained from an alkylphenol and formaldehyde. Examples of the alkylphenol resin include novolac-type and resole-type resins.

The rosin phenol resin is typically a phenol-modified product of rosins or various rosin derivatives (including rosin esters, unsaturated fatty acid-modified rosins, and unsaturated fatty acid-modified rosin esters) described above. Examples of the rosin phenol resin include a rosin phenol resin obtained, for example, by a method of adding a phenol to rosins or various rosin derivatives above with the aid of an acid catalyst and thermally polymerizing the mixture.

Examples of the terpene-based tackifying resin include polymers of terpenes (typically monoterpenes) such as α-pinene, β-pinene, d-limonene, l-limonene and dipentene.

The polymer may be a homopolymer of one type of terpenes or a copolymer of two or more types of terpenes. The homopolymer of one type of terpenes includes an α-pinene polymer, a β-pinene polymer, a dipentene polymer, etc.

Examples of the modified terpene resin include those obtained by modifying the terpene resins above. Specific examples include a styrene-modified terpene resin, a hydrogenated terpene resin, etc.

The concept of the rosin-based tackifying resin as used herein encompasses both rosins and rosin derivative resins. Examples of the rosins include an unmodified rosin (raw rosin) such as gum rosin, wood rosin and tall oil rosin; and a modified rosin obtained by modifying the unmodified rosin by hydrogenation, disproportionation, polymerization, etc. (e.g., a hydrogenated rosin, a disproportionated rosin, a polymerized rosin, and other chemically modified rosins).

The rosin derivative resin is typically a derivative of the above-described rosins. The concept of the rosin-based resin as used herein encompasses derivatives of the unmodified rosin and derivatives of the modified rosin (including a hydrogenated rosin, a disproportionated rosin and a polymerized rosin).

The rosin-based resin includes: for example, rosin esters such as an unmodified rosin ester that is an ester of the unmodified rosin and alcohols, and a modified rosin ester that is an ester of the modified rosin and alcohols; for example, unsaturated fatty acid-modified rosins obtained by modifying the rosins with an unsaturated fatty acid; for example, unsaturated fatty acid-modified rosin esters obtained by modifying the rosin esters with an unsaturated fatty acid; for example, rosin alcohols obtained by reducing the carboxy group of rosins or various rosin derivatives above (including rosin esters, unsaturated fatty acid-modified rosins and unsaturated fatty acid-modified rosin esters); for example, metal salts of rosins or various rosin derivatives above; etc.

Specific examples of the rosin esters include a methyl ester, triethylene glycol ester, glycerin ester and pentaerythritol ester of an unmodified rosin or a modified rosin (a hydrogenated rosin, a disproportionated rosin, a polymerized rosin, etc.).

Examples of the hydrocarbon-based tackifying resin include various hydrocarbon-based resins such as aliphatic hydrocarbon resin, aromatic hydrocarbon resin, aliphatic cyclic hydrocarbon resin, aliphatic-aromatic petroleum resin (styrene-olefin copolymer, etc.), aliphatic-alicyclic petroleum resin, hydrogenated hydrocarbon resin, coumarone resin and coumarone indene resin.

The softening point of the tackifying resin is not particularly limited. From the viewpoint of enhancing the cohesive force, in one aspect, a tackifying resin having a softening point (softening temperature) of 80° C. or more, preferably 100° C. or more, may be favorably employed.

The technique disclosed herein may be preferably implemented in a mode where when the total amount of tackifying resins contained in the pressure-sensitive adhesive layer is taken as 100 mass %, the tackifying resin having the above-described softening point accounts for more than 50 mass %, more preferably more than 70 mass %, still more preferably more than 90 mass %.

For example, a phenolic tackifying resin (terpene phenol resin, etc.) having such a softening point may be advantageously used. The tackifying resin may include, for example, a terpene phenol resin having a softening point of 135° C. or more or 140° C. or more.

The upper limit of the softening point of the tackifying resin is not particularly limited. From the viewpoint of enhancing the adhesiveness to an adherend, in one aspect, a tackifying resin having a softening point of 200° C. or less (more preferably 180° C. or less) may be favorably used. In one preferred aspect, the softening point of the tackifying resin (typically a terpene phenol resin) is less than 130° C., for example, 120° C. or less.

Use of a tackifying resin thus having a relatively low softening point enables, for example, the improvement of dispersibility of the pigment.

Incidentally, the softening point of the tackifying resin can be measured based on the softening point test method (ring and ball method) specified in HS K2207.

One preferred aspect is an embodiment where the tackifying resin includes one of phenolic tackifying resins (typically, terpene phenol resins) or two or more thereof.

The technique disclosed herein may be preferably implemented, for example, in a mode where when the total amount of tackifying resins is taken as 100 mass %, the terpene phenol resin accounts for 25 mass % or more, more preferably 30 mass % or more.

Out of the total amount of the tackifying resins, 50 mass % or more may be a terpene phenol resin, 80 mass % or more may be a terpene phenol resin, or 90 mass % or more may be a terpene phenol resin. Also, out of the total amount of the tackifying resins, from 95 to 100 mass %, furthermore, from 99 to 100 mass %, may be a terpene phenol resin, and substantially all of the tackifying resins may be a terpene phenol resin.

Although not particularly limited, in the pressure-sensitive adhesive composition forming the pressure-sensitive adhesive layer of this embodiment, the tackifying resin may include a tackifying resin having a hydroxyl value of more than 20 mg KOH/g. Among others, a tackifying resin having a hydroxyl value of 30 mg KOH/g or more is preferred. Hereinafter, a tackifying resin having a hydroxyl value of 30 mg KOH/g or more is sometimes referred to as a “high hydroxyl value resin”.

By using the tackifying resin including such a high hydroxyl value resin, a pressure-sensitive adhesive layer having excellent adhesiveness to an adherend and high cohesive force is obtained.

In one aspect, the tackifying resin may include a high hydroxyl value resin having a hydroxyl value of 50 mg KOH/g or more, preferably 70 mg KOH/g or more.

As the hydroxyl value, values measured by the potentiometric titration method specified in JIS K0070:1992 may be employed.

As the high hydroxyl value resin, among various tackifying resins described above, those having a hydroxyl value not less than a predetermined value may be used. One of high hydroxyl value resins may be used alone, or two or more thereof may be used in combination. For example, as the high hydroxyl value resin, a phenolic tackifying resin having a hydroxyl value of 30 mg KOH/g or more may be preferably used.

In one preferred aspect, at least a terpene phenol resin having a hydroxyl value 30 mg KOH/g or more is used as the tackifying resin. The terpene phenol resin is advantageous in that the hydroxyl value can arbitrarily be controlled by the copolymerization ratio of phenol.

The upper limit of the hydroxyl value of the high hydroxyl value resin is not particularly limited. In view of, e.g., compatibility with the base polymer, the hydroxyl value of the high hydroxyl value resin is, usually, suitably 200 mg KOH/g or less, preferably 180 mg KOH/g or less, more preferably 160 mg KOH/g or less, still more preferably 140 mg KOH/g or less.

This embodiment may be preferably implemented in a mode where the tackifying resin includes a high hydroxyl value resin (for example, a phenolic tackifying resin, preferably a terpene phenol resin) having a hydroxyl value of 30 to 160 mg KOH/g.

In one aspect, a high hydroxyl value resin having a hydroxyl value of 30 to 80 mg KOH/g may be preferably employed, and a high hydroxyl value resin having a hydroxyl value of 30 to 65 mg KOH/g may be more preferably employed.

In another aspect, a high hydroxyl value resin having a hydroxyl value of 70 to 140 mg KOH/g may be preferably employed.

Although not particularly limited, in the case of using a high hydroxyl value resin, the proportion of the high hydroxyl value resin (for example, a terpene phenol resin) in the entire tackifying resins contained in the pressure-sensitive adhesive composition forming the pressure-sensitive adhesive layer may be, for example, 25 mass % or more. The proportion is preferably 30 mass % or more, more preferably 50 mass % or more, still more preferably 80 mass % or more, yet still more preferably 90 mass % or more. In addition, substantially all of the tackifying resins may be a high hydroxyl value resin, and, for example, from 95 to 100 mass %, and furthermore, from 99 to 100 mass %, may be a high hydroxyl value resin.

In the case where the pressure-sensitive adhesive composition forming the pressure-sensitive adhesive layer includes a tackifying resin, the amount used of the tackifying resin is not particularly limited and, for example, may be appropriately set in the range of 1 to 100 parts by mass per 100 parts by mass of the base polymer.

From the viewpoint of successfully exhibiting the effect of enhancing the peel strength, the amount used of the tackifying resin per 100 parts by mass of the base polymer (for example, an acrylic polymer) is, usually, suitably 5 parts by mass or more, preferably 10 parts by mass or more, or may be 15 parts by mass or more.

For example, in the pigment-containing pressure-sensitive adhesive layer, the dispersibility of the pigment tends to be enhanced by incorporating a predetermined amount of a tackifying resin (e.g., a terpene phenol resin having a softening point of 120° C. or less).

Also, in view of the heat-resistant cohesive force, the amount used of the tackifying resin per 100 parts by mass of the base polymer (for example, an acrylic polymer) is usually, suitably 50 parts by mass or less, may be 40 parts by mass or less, or may be 30 parts by mass or less.

### [Crosslinking Agent]

The pressure-sensitive adhesive composition forming the pressure-sensitive adhesive layer of this embodiment may contain a crosslinking agent, if desired. The type of the crosslinking agent is not particularly limited, and a crosslinking agent appropriately selected from conventionally known crosslinking agents may be used.

The crosslinking agent includes, for example, an isocyanate-based crosslinking agent, an epoxy-based crosslinking agent, an oxazoline-based crosslinking agent, an aziridine-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, a hydrazine-based crosslinking agent, an amine-based crosslinking agent, a silane coupling agent, etc. One of these crosslinking agents may be used alone, or two or more thereof may be used in combination.

In one preferred aspect, as the crosslinking agent, an isocyanate-based crosslinking agent and at least one crosslinking agent having a crosslinkable functional group differing in type from the isocyanate-based crosslinking agent are used in combination.

According to the technique disclosed herein, when an isocyanate-based crosslinking agent and a crosslinking agent other than an isocyanate-based crosslinking agent (i.e., a crosslinking agent differing in the type of the crosslinkable functional group from an isocyanate crosslinking agent; hereinafter, sometimes referred to as “non-isocyanate-based crosslinking agent”) are used in combination, both high heat-resistant cohesive force and excellent metal corrosion inhibition can be successfully achieved, for example, in a configuration containing a rust inhibitor such as azole-based rust inhibitor.

Incidentally, the pressure-sensitive adhesive layer in the technique disclosed herein may contain the crosslinking agent, e.g., in a crosslinked form, in a pre-crosslinked form, in a partially crosslinked form, or in an intermediate or composite form of these. Typically, the crosslinking agent is contained in the pressure-sensitive adhesive layer mostly in a crosslinked form.

As the isocyanate-based crosslinking agent, a polyfunctional isocyanate (which refers to a compound having, on average, two or more isocyanate groups per molecule; encompassing a compound having an isocyanurate structure) may be preferably used. One of the isocyanate-based crosslinking agents may be used alone, or two or more thereof may be used in combination.

Examples of the polyfunctional isocyanate include aliphatic polyisocyanates, alicyclic polyisocyanates, aromatic polyisocyanates, etc.

Specific examples of the aliphatic polyisocyanates include 1,2-ethylene diisocyanate; tetramethylene diisocyanates such as 1,2-tetramethylene diisocyanate, 1,3-tetramethylene diisocyanate and 1,4-tetramethylene diisocyanate; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate and 2,5-hexamethylene diisocyanate; 2-methyl-1,5-pentane diisocyanate, 3-methyl-1,5-pentane diisocyanate, lysine diisocyanate, etc.

Specific examples of the alicyclic polyisocyanates include isophorone diisocyanate; cyclohexyl diisocyanates such as 1,2-cyclohexyl diisocyanate, 1,3-cyclohexyl diisocyanate and 1,4-cyclohexyl diisocyanate; cyclopentyl diisocyanates such as 1,2-cyclopentyl diisocyanate and 1,3-cyclopentyl diisocyanate; hydrogenated xylylene diisocyanate, hydrogenated tolylene diisocyanate, hydrogenated diphenylmethane diisocyanate, hydrogenated tetramethylxylene diisocyanate, 4,4′-dicyclohexylmethane diisocyanate, etc.

Specific examples of the aromatic polyisocyanates include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, xylylene-1,3-diisocyanate, etc.

Preferable polyfunctional isocyanates include, for example, a polyfunctional isocyanate having, on average, three or more isocyanate groups per molecule. Such a tri- or higher functional isocyanate may be a multimer (typically a dimer or a trimer), derivative (e.g., an adduct of a polyol and two or more molecules of polyfunctional isocyanate), polymerization product, etc. of a bifunctional or tri- or higher functional isocyanate.

The polyfunctional isocyanate above includes, for example, polyfunctional isocyanates such as a dimer or trimer of diphenylmethane diisocyanate, an isocyanurate form (a trimer adduct having isocyanurate structure) of hexamethylene diisocyanate, a reaction product of trimethylol propane and tolylene diisocyanate, a reaction product of trimethylol propane and hexamethylene diisocyanate, polymethylene polyphenyl isocyanate, polyether polyisocyanate and polyester polyisocyanate.

Commercially available products of such a polyfunctional isocyanate include a product under trade name “DURANATE TPA-100” produced by Asahi Kasei Chemicals Corporation and products under trade name “CORONATE L”, trade name “CORONATE HL”, trade name “CORONATE HK”, trade name “CORONATE HX”, and trade name “CORONATE 2096”, etc. produced by Tosoh Corporation.

The amount used of the isocyanate-based crosslinking agent is not particularly limited. For example, the amount used may be 0.5 parts by mass or more per 100 parts by mass of the base polymer.

From the viewpoint of obtaining higher cohesive force (particularly heat-resistant cohesive force), the amount used of the isocyanate-based crosslinking agent per 100 parts by mass of the base polymer can be, for example, 1.0 parts by mass or more and may also be preferably 1.5 parts by mass or more, more preferably 2.0 parts by mass or more, still more preferably 2.5 parts by mass or more.

On the other hand, from the viewpoint of enhancing the adhesiveness to an adherend, the amount used of the isocyanate-based crosslinking agent is, usually, suitably 10 parts by mass or less per 100 parts by mass of the base polymer and may also be 8 parts by mass or less, or 5 parts by mass or less.

The type of the non-isocyanate-based crosslinking agent used in combination with the isocyanate-based crosslinking agent is not particularly limited, and those appropriately selected from the above-described crosslinking agents may be used. One of the non-isocyanate-based crosslinking agents may be used alone, or two or more thereof may be used in combination.

In one preferred aspect, an epoxy-based crosslinking agent may be used as the non-isocyanate-based crosslinking agent. As for the epoxy-based crosslinking agent, the compounds having two or more epoxy groups per molecule can be used without particular limitation. An epoxy-based crosslinking agent having from 3 to 5 epoxy groups per molecule is preferred. One of the epoxy-based crosslinking agents may be used alone, or two or more thereof may be used in combination.

Although not particularly limited, specific examples of the epoxy-based crosslinking agent include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, polyglycerol polyglycidyl ether, etc.

Commercially available products of the epoxy-based crosslinking agent include products under trade name “TETRAD-C” and trade name “TETRAD-X” produced by Mitsubishi Gas Chemical Co., Inc., a product under trade name “EPICLON CR-5L” produced by DIC Corp., a product under trade name “DENACOL EX-512” produced by Nagase ChemteX Corporation, a product under trade name “TEPIC-G” produced by Nissan Chemical Industries, Ltd., etc.

The amount used of the epoxy-based crosslinking agent is not particularly limited. The amount used of the epoxy-based crosslinking agent may be, for example, more than 0 part by mass and 1 part by mass or less, typically from 0.001 to 0.5 parts by mass, per 100 parts by mass of the base polymer.

From the viewpoint of successfully obtaining the effect of increasing the cohesive force, the amount used of the epoxy-based crosslinking agent is, usually, suitably 0.002 parts by mass or more, preferably 0.005 parts by mass or more, more preferably 0.008 parts by mass or more, per 100 parts by mass of the base polymer.

Also, from the viewpoint of enhancing the adhesiveness to an adherend, the amount used of the epoxy-based crosslinking agent is, usually, suitably 0.2 parts by mass or less, preferably 0.1 parts by mass or less, more preferably less than 0.05 parts by mass, still more preferably less than 0.03 parts by mass, yet still more preferably 0.025 parts by mass or less, per 100 parts by mass of the base polymer.

In this embodiment, the relationship between the content of the isocyanate-based crosslinking agent and the content of the non-isocyanate-based crosslinking agent (e.g. an epoxy-based crosslinking agent) is not particularly limited. The content of the non-isocyanate-based crosslinking agent may be, for example, 1/50 or less of the content of the isocyanate-based crosslinking agent.

From the viewpoint of more successfully achieving both the adhesiveness to an adherend and the cohesive force, the content of the non-isocyanate-based crosslinking agent is, on the mass basis, suitably 1/75 or less, preferably 1/100 or less, more preferably 1/150 or less, of the content of the isocyanate-based crosslinking agent.

In addition, from the viewpoint of successfully obtaining the effect due to using the isocyanate-based crosslinking agent and the non-isocyanate-based crosslinking agent (e.g. an epoxy-based crosslinking agent) in combination, the content of the non-isocyanate-based crosslinking agent is, usually, suitably 1/1000 or more, for example, 1/500 or more, of the content of the isocyanate-based crosslinking agent.

The total amount used of the crosslinking agent is not particularly limited. For example, the total amount may be 10 parts by mass or less per 100 parts by mass of the base polymer (suitably an acrylic polymer) and may be selected from the range of preferably from 0.005 to 10 parts by mass, more preferably from 0.01 to 5 parts by mass.

In addition, the pressure-sensitive adhesive composition forming the pressure-sensitive adhesive layer may contain, if desired, various additives generally used in the field of pressure-sensitive adhesive, such as leveling agent, crosslinking aid, plasticizer, softening agent, antistatic agent, anti-aging agent, ultraviolet absorber, antioxidant and light stabilizer.

As for these various additives, conventionally known additives can be used by conventional methods and since they do not particularly characterize the present invention, detailed description thereof is omitted.

The pressure-sensitive adhesive layer of this embodiment may be a pressure-sensitive adhesive layer formed from an aqueous pressure-sensitive adhesive composition, a solvent-type pressure-sensitive adhesive composition, a hot-melt pressure-sensitive adhesive composition, or an active energy ray-curable pressure-sensitive adhesive composition.

The aqueous pressure-sensitive adhesive composition refers to a pressure-sensitive adhesive composition in the form of containing a pressure-sensitive adhesive (pressure-sensitive adhesive layer-forming component) in a solvent using water as the main component (an aqueous solvent) and typically includes those referred to as an aqueous dispersion-type pressure-sensitive adhesive composition (a composition in the form of at least part of the pressure-sensitive adhesive being dispersed in water), etc.

Also, the solvent-type pressure-sensitive adhesive composition refers to a pressure-sensitive adhesive composition in the form of containing a pressure-sensitive adhesive in an organic solvent.

In view of pressure-sensitive adhesive properties, this embodiment may be preferably implemented in a mode of having a pressure-sensitive adhesive layer formed from a solvent-type pressure-sensitive adhesive composition.

In the case where the pressure-sensitive adhesive layer has a multilayer structure of two or more layers, the layer can be formed by sticking previously formed pressure-sensitive adhesive layers together. Alternatively, after applying the pressure-sensitive adhesive composition on a previously formed first pressure-sensitive adhesive layer, the pressure-sensitive adhesive composition may be cured to form a second pressure-sensitive adhesive layer.

In the case where the pressure-sensitive adhesive layer possessed by the later-described pressure-sensitive adhesive sheet that is used in an application mode of attaching to an adherend and then photocuring, has a multilayer structure, the pressure-sensitive adhesive layer to be photocured may be a part (for example, one layer) of the layers included in the multilayer structure or may be all layers.

In the case of forming the pressure-sensitive adhesive layer by applying the pressure-sensitive adhesive composition, this can be implemented, for example, using a commonly used coater such as gravure roll coater, reverse roll coater, kiss roll coater, dip roll coater, bar coater, knife coater and spray coater.

In the later-described pressure-sensitive adhesive sheet in the form of having a substrate, as the method for forming the pressure-sensitive adhesive layer on the substrate, a direct method of directly applying the pressure-sensitive adhesive composition to the substrate to form the pressure-sensitive adhesive layer may be used, or a transfer method of transferring the pressure-sensitive adhesive layer formed on a release surface to the substrate may be used.

The thickness of the pressure-sensitive adhesive layer is not particularly limited and may be, for example, from 3 μm to 2,000 μm. In view of adhesiveness to an adherend, such as unevenness followability, in some embodiments, the thickness of the pressure-sensitive adhesive layer may be, for example, 5 μm or more and is suitably 10 μm or more, preferably 20 μm or more, more preferably 30 μm or more.

The thickness of the pressure-sensitive adhesive layer may be 50 μm or more, may be more than 50 μm, may be 70 μm or more, may be 100 μm or more, or may be 120 μm or more.

Also, from the viewpoint of preventing adhesive residue due to cohesive failure in the pressure-sensitive adhesive layer, in some embodiments, the thickness of the pressure-sensitive adhesive layer may be, for example, 1,000 μm or less, may be 700 μm or less, may be 500 μm or less, may be 300 μm or less, may be 200 μm or less, or may be 170 μm or less.

The technique according to this embodiment may also be suitably implemented in the mode of the later-described pressure-sensitive adhesive sheet where the thickness of the pressure-sensitive adhesive layer is 130 μm or less, 90 μm or less, 60 μm or less, or 40 μm or less.

Incidentally, in the later-described pressure-sensitive adhesive sheet including a pressure-sensitive adhesive layer having a multilayer structure of two or more layers, the thickness of the pressure-sensitive adhesive layer refers to the thickness from the pressure-sensitive adhesive surface adhered to an adherend to the surface opposite the pressure-sensitive adhesive surface.

### <Pressure-Sensitive Adhesive Sheet>

The pressure-sensitive adhesive sheet in one embodiment of the present invention includes the pressure-sensitive adhesive layer above. The pressure-sensitive adhesive sheet of this embodiment may be a substrate-attached pressure-sensitive adhesive sheet in the form of having the pressure-sensitive adhesive layer on one surface (FIG. 2) or both surfaces (FIG. 3) of a sheet-like substrate (support), or a substrateless pressure-sensitive adhesive sheet, for example, in the form of the pressure-sensitive adhesive layer being held by a release sheet.

The concept of the pressure-sensitive adhesive sheet as used herein may encompass those referred to as a pressure-sensitive adhesive tape, a pressure-sensitive adhesive label, a pressure-sensitive adhesive film, etc.

Incidentally, the pressure-sensitive adhesive layer is, typically, continuously formed but is not limited to such a configuration and may be, for example, a pressure-sensitive adhesive layer formed in a regular or random pattern of dots, stripes, etc.

In addition, the pressure-sensitive adhesive sheet of this embodiment may be in a roll form or in a flat sheet form and furthermore, may be a pressure-sensitive adhesive sheet in the form of being processed into various shapes.

In view of having unevenness followability, the pressure-sensitive adhesive sheet of this embodiment is preferably in a substrateless mode of not having a substrate as illustrated in FIG. 1. In the case where an object to which the pressure-sensitive adhesive sheet is attached has unevenness (for example, 10 μm), since the pressure-sensitive adhesive sheet has unevenness followability, the pressure-sensitive adhesive sheet can be attached along the unevenness, so that the waterproofness of the object can be enhanced.

Also, the pressure-sensitive adhesive sheet of this embodiment may include a supporting substrate as illustrated in FIG. 2. This allows the pressure-sensitive adhesive sheet to be accurately processed by punching, etc. Such a pressure-sensitive adhesive sheet is suited for usage where the sheet is utilized after processing into a specific shape or narrowing the width.

Also, the thickness of the supporting substrate in this embodiment is, for example, less than 75 μm. The supporting substrate of which thickness is limited is favorably utilized for usage where thinning or weight reduction is required.

In addition, for example, when the thickness of the supporting substrate is limited and the thickness of the pressure-sensitive adhesive layer is thereby relatively increased, this enables to enhance the pressure-sensitive adhesive properties such as peel strength and impact resistance. From such a viewpoint, the thickness of the supporting substrate is preferably 60 μm or less, more preferably 50 μm or less, still more preferably less than 50 μm, yet still more preferably 40 μm or less, even yet still more preferably 30 μm or less, more preferably less than 30 μm, still more preferably 25 μm or less.

In one aspect, the thickness of the supporting substrate may be 20 μm or less, may be 12 μm or less, may be 7 μm or less, or may be 3 μm or less.

The lower limit of the thickness of the supporting substrate is not particularly limited. In view of the handling property (handleability), processability, etc. of the pressure-sensitive adhesive sheet, the thickness of the supporting substrate is usually 0.5 μm or more, for example, 1 μm or more.

In one aspect, the thickness of the supporting substrate may be 3 μm or more. In another aspect, the thickness of the supporting substrate may be 8 μm or more, may be 13 μm or more, or may be 16 μm or more.

The structure and material of the supporting substrate are not particularly limited, and the supporting substrate is typically a film-like substrate (sometimes referred to as “substrate film”). As for the substrate film, a film including a resin film as the base film may be preferably used.

The base film is typically a member capable of independently maintaining the shape (an independent member). The substrate film in this embodiment may be a film substantially composed of such a base film. Alternatively, the substrate film may be a film including a secondary layer in addition to the base film. Examples of the secondary layer include a colored layer, a reflective layer, a primer layer, an antistatic layer, etc. provided on the surface of the base film.

The resin film is a film containing a resin material as the main component (for example, a component contained in an amount in excess of 50 mass % in the resin film).

Examples of the resin film include a polyolefin-based resin film such as polyethylene (PE), polypropylene (PP) and ethylene-propylene copolymer; a polyester-based resin film such as polyethylene terephthalate (PET), polybutylene terephthalate (PBT) and polyethylene naphthalate (PEN); a polyurethane-based resin film; a vinyl chloride-based resin film; a vinyl acetate-based resin film; a polyimide-based resin film; a polyamide-based resin film; a fluororesin film; cellophane; etc.

The resin film may also be a rubber-based film such as natural rubber film and butyl rubber film. Above all, in view of the handleability and processability, a polyester film is preferred and among these, a PET film is more preferred.

Incidentally, the “resin film” as used in the present description typically refers to a non-porous sheet and is a concept distinguished from so-called nonwoven and woven fabrics (in other words, a concept excluding nonwoven and woven fabrics).

The substrate film (typically a resin film) may contain the pigment above. This enables to adjust the optical transparency or light-blocking property of the substrate film.

The amount used of the pigment in the substrate film is not particularly limited and may be an amount appropriately adjusted so that desired optical properties can be imparted. The amount used of the pigment is, usually, suitably from 0.1 to 30 mass % of the total mass of the substrate film and may be, for example, from 0.1 to 25 mass %, typically from 0.1 to 20 mass %.

In the substrate film, various additives such as filler (inorganic filler, organic filler, etc.), dispersant (surfactant, etc.), anti-aging agent, antioxidant, ultraviolet absorber, antistatic agent, slip agent and plasticizer may be blended, if desired. The blending ratio of these various additives is usually less than 30 mass %, less than 20 mass %, or typically, less than 10 mass %.

The substrate film may have a single-layer structure or a multilayer structure of two, three or more layers.

In view of the shape stability, the substrate film preferably has a single-layer structure. In the case of a multilayer structure, at least one layer (preferably all layers) is preferably a layer having a continuous structure formed of the resin above (for example, a polyester-based resin, typically a black colorant-containing resin).

The method for producing the substrate film (typically a resin film) is not particularly limited, and a conventionally known method may be appropriately employed. For example, a conventionally known general film-forming method such as extrusion molding, inflation molding, T-die cast molding and calender roll molding can be appropriately employed.

The substrate film may be colored with a colored layer arranged on the surface of the base film (preferably a resin film). In the substrate film having such a configuration including a base film and a colored layer, the base film may or may not contain a colorant.

The colored layer may be arranged on either one surface of the base film or may be arranged on each of two surfaces. In a configuration where a colored layer is arranged on each of two surfaces of the base film, respective colored layers may be of the same or different configurations.

Such a colored layer can be formed typically by coating the base film with a colored layer-forming composition containing a colorant and a binder.

As the colorant, conventionally known pigments or dyes can be used. As the binder, materials known in the paint or printing field can be used without any particular limitation. Examples thereof include polyurethane, a phenol resin, an epoxy resin, a urea-melamine resin, and polymethyl methacrylate.

The colored layer-forming composition may be, for example, a solvent type, a UV-curable type, a thermosetting type, etc. The colored layer can be formed using, without any particular limitation, a method that has been conventionally employed for the formation of a colored layer. For example, a method of forming the colored layer (printed layer) by printing such as gravure printing, flexographic printing or offset printing may be preferably employed.

The colored layer may have a single-layer structure in which the entirety is composed of one layer, or may have a multilayer structure including two, three or more colored sublayers.

The colored layer having a multilayer structure including two or more colored sublayers can be formed, for example, by repeatedly applying (for example, printing) the colored layer-forming composition.

The colors and blending amounts of colorants contained in respective colored sublayers may be the same or different. From the viewpoint of preventing formation of pinholes and thereby increasing the reliability of light leakage prevention, it is particularly meaningful to configure a colored layer for providing a light-blocking property as having a multilayer structure.

The thickness of the entire colored layer is, usually, suitably from 1 μm to 10 μm, preferably from 1 μm to 7 μm, and may be, for example, from 1 μm to 5 μm. In a colored layer including two or more colored sublayers, the thickness of each colored sublayer is, usually, preferably from 1 μm to 2 μm.

The surface of the substrate film may be subjected to a conventionally known surface treatment such as corona discharge treatment, plasma treatment, ultraviolet irradiation treatment, acid treatment, alkali treatment and primer coating. Such a surface treatment may be a treatment for enhancing the adhesiveness between the substrate film and the pressure-sensitive adhesive layer, in other words, the anchoring property of the pressure-sensitive adhesive layer to the substrate film. Also, in the case where the technique disclosed herein is implemented in the mode of a substrate-attached single-sided pressure-sensitive adhesive sheet, the backside of the substrate film may be subjected to a release treatment, if desired. The release treatment may be, for example, a treatment where a general release treatment agent such as silicone-based, long-chain alkyl-based or fluorine-based release treatment agent is applied in a thin film fashion of typically from 0.01 μm to 1 μm, for example, from 0.01 μm to 0.1 μm.

Such a release treatment produces an effect of, for example, facilitating unwinding of a roll formed by winding the pressure-sensitive adhesive sheet in a roll fashion.

In the pressure-sensitive adhesive sheet of this embodiment, a release liner can be used at the time of formation of the pressure-sensitive adhesive layer, production of the pressure-sensitive adhesive sheet, and storage, distribution, shape-processing, etc. of the pressure-sensitive adhesive sheet before use.

The release liner is not particularly limited and, for example, a release liner having a release-treated layer on the surface of a liner substrate such as resin film or paper, or a release liner formed of a low-adhesive material such as fluoropolymer (polytetrafluoroethylene, etc.) or polyolefin-based resin (polyethylene, polypropylene, etc.), can be used.

The release-treated layer can be formed, for example, by subjecting the liner substrate to a surface treatment with a release treatment agent such as silicone-based, long-chain alkyl-based or fluorine-based release treatment agent or molybdenum sulfide.

### (Thickness of Pressure-Sensitive Adhesive Sheet)

The total thickness of the pressure-sensitive adhesive sheet (including a pressure-sensitive adhesive layer and in the configuration having a supporting substrate, further including a supporting substrate but not including a release liner) is not particularly limited.

In view of thinning, the total thickness of the pressure-sensitive adhesive sheet is, usually, suitably 200 μm or less. The lower limit of the thickness of the pressure-sensitive adhesive sheet is not particularly limited, and the thickness may be usually 1 μm or more, suitably, for example, 3 μm or more, and is preferably 6 μm or more, or more preferably 10 μm or more, still more preferably 15 μm or more.

In one preferred aspect, the total thickness of the pressure-sensitive adhesive sheet is 150 μm or less, preferably 120 μm or less, more preferably 70 μm or less, still more preferably 50 μm or less, yet still more preferably 40 μm or less, even yet still more preferably 35 μm or less, more preferably 25 μm or less, still more preferably 15 μm or less, yet still more preferably 10 μm or less, and even yet still more preferably 7 μm or less.

In a configuration using such a thin pressure-sensitive adhesive sheet, the light-blocking effect of this embodiment can also be successfully exhibited.

The ratio of the combined thickness of pressure-sensitive adhesive layers included in the pressure-sensitive adhesive sheet to the total thickness of the pressure-sensitive adhesive sheet is not particularly limited. Here, the combined thickness of pressure-sensitive adhesive layers included in the pressure-sensitive adhesive sheet refers to the combined thickness of the pressure-sensitive adhesive layer provided on one surface of the substrate film and the pressure-sensitive adhesive layer provided on another surface.

In the case of a single-sided pressure-sensitive adhesive sheet where the pressure-sensitive adhesive layer is provided only on one surface of the substrate film, the thickness of the pressure-sensitive adhesive layer provided on another surface is zero, and the thickness of the pressure-sensitive adhesive layer provided on one surface coincides with the combined thickness of pressure-sensitive adhesive layers.

The technique disclosed herein may be preferably implemented in a mode where, for example, the ratio of the combined thickness of pressure-sensitive adhesive layers to the total thickness of the pressure-sensitive adhesive sheet is 40% or more, preferably 50% or more, more preferably more than 50%, still more preferably 60% or more, or yet still more preferably 70% or more. By employing such a configuration, a higher level of impact resistance tends to be exhibited even when the width is narrow relative to the total thickness of the pressure-sensitive adhesive sheet.

In one aspect, the ratio of the combined thickness of pressure-sensitive adhesive layers to the total thickness of the pressure-sensitive adhesive sheet may be 75% or more and furthermore, may be 80% or more.

The upper limit of the ratio of the combined thickness of pressure-sensitive adhesive layers to the total thickness of the pressure-sensitive adhesive sheet is not particularly limited, but the ratio is, usually, suitably 95% or less and preferably 90% or less.

### (Properties of Pressure-Sensitive Adhesive Sheet)

In the pressure-sensitive adhesive sheet of this embodiment, the 180° peel adhesion (N/25 mm) to an SUS304BA plate is preferably 3 N/25 mm or more, more preferably 5 N/25 mm or more, still more preferably 10 N/25 mm or more.

The pressure-sensitive adhesive force above can be measured by performing a peel adhesion test in conformity with JIS Z 0237:2009.

More specifically, in an environment at 23° C. and 50% RH, a PET film having a thickness of 50 μm is attached to one pressure-sensitive adhesive surface of a double-sided pressure-sensitive adhesive sheet to serve as a backing, and the lined sheet is cut to a width of 25 mm to prepare a measurement sample. Another pressure-sensitive adhesive surface of the measurement sample is attached to an SUS304BA plate serving as an adherend over an adhesion area of 25 mm in width and 100 mm in length by reciprocating a 2-kg roller once. The measurement sample thus attached to the adherend is left standing for 5 days in an environment of 65° C. and 90% RT. Thereafter, the force (N/25 mm) when peeling the measurement sample from the adherend at a peel angle of 180° and a tensile speed of 300 mm/min is measured.

### <Usage>

The pressure-sensitive adhesive sheet of this embodiment has excellent processing accuracy and therefore, is suited for usage where the sheet is utilized after processing into a specific shape or narrowing the width, for example, for the fixing of a member in a portable electronic device.

Some of electronic devices such as portable electronic device include a luminescent element for the purpose of image display, etc. and therefore, the pressure-sensitive adhesive sheet may be required to have light-blocking property. Also, some devices utilize infrared light, and the pressure-sensitive adhesive sheet may be required not only to have light-blocking property for visible light but also to selectively transmit infrared light.

The pressure-sensitive adhesive sheet of this embodiment has wavelength selectivity of blocking visible light and transmitting infrared light and therefore, can also respond to the needs of the devices above.

Non-limiting examples of the portable electronic device include a mobile phone, a smartphone, a tablet personal computer, a laptop computer, various wearable devices (for example, a wrist-wearable type that is worn on a wrist, such as wristwatch; a modular type that is worn on a body part by means of a clip, a strap, etc.; an eyewear type encompassing an eyeglass type (monocular or binocular; including a head-mounted type); a clothing type that is worn in the form of, for example, accessories on shirts, socks, hats/caps, etc.; an earwear type that is attached to the ear, such as earphones), a digital camera, a digital video camera, acoustic equipment (a portable music player, an IC recorder, etc.), a calculator (e.g., a pocket calculator), a portable game machine, an electronic dictionary, an electronic notebook, an e-book reader, an in-vehicle information system, a portable radio, a portable TV, a portable printer, a portable scanner, a portable modem, etc.

Incidentally, the “portable” as used in the present description means to have portability at a level allowing for relatively easy carrying by an individual (average adult), and it is not sufficient to be simply capable of being carried.

Among these portable electronic devices, for example, in a portable electronic device having a pressure-sensitive sensor, the pressure-sensitive adhesive sheet of this embodiment may be preferably used for the purpose of fixing the pressure-sensitive sensor and other members.

In one preferred aspect, the pressure-sensitive adhesive sheet may be used for fixing a pressure-sensitive sensor and other members inside an electronic device (typically, a portable electronic device) equipped with a function of, by use of a unit for instructing a position on a screen (typically, a pen-type or mouse-type unit) and a unit for detecting the position, enabling the designation of an absolute position on a panel (typically, a touch panel) corresponding to the screen.

The pressure-sensitive adhesive sheet of this embodiment is also suitable for usage where the sheet is arranged on the back of a display screen (display) such as touch panel display in a portable electronic device and prevents light reflection on the display screen.

By arranging the pressure-sensitive adhesive sheet of this embodiment on the back of the display screen (display), the visibility of the display screen can be prevented from degradation regardless of how the portable electronic device is used.

In addition, although the reflection above may be caused by a metallic member arranged on the backside of the display screen, when the pressure-sensitive adhesive sheet disclosed herein is used, for example, for the joining of the metallic member and the display, joining the member and imparting light-blocking property can be realized at the same time.

The material constituting the fixing target (for example, a backside member such as electromagnetic shielding material and reinforcing plate) to the pressure-sensitive sensor, display, etc. is not particularly limited.

Examples thereof include a metal material such as copper, silver, gold, iron, tin, palladium, aluminum, nickel, titanium, chromium, zinc and an alloy including two or more of these metals; various resin materials (typically, a plastic material) such as polyimide-based resin, acrylic-based resin, polyether nitrite-based resin, polyethersulfone-based resin, polyester-based resin (e.g., polyethylene terephthalate-based resin, polyethylene naphthalate-based resin), polyvinyl chloride-based resin, polyphenylene sulfide-based resin, polyether ether ketone-based resin, polyamide-based resin (e.g., so-called aramid resin), polyarylate-based resin, polycarbonate-based resin and liquid crystal polymer; an inorganic material such as alumina, zirconia, soda glass, silica glass and carbon; etc.

Among these, a metal material such as copper, aluminum and stainless steel, and a resin material (typically a plastic material) such as polyimide-based resin, aramid resin and polyphenylene sulfide-based resin are widely used.

The fixing target may be in either form of a single-layer structure or a multilayer structure, and the surface (adhesion surface) to which the pressure-sensitive adhesive sheet is applied may be subjected to various surface treatments.

Although not particularly limited, the fixing target includes, as one example, a backside member having a thickness of 1 μm or more, 5 μm or more, 60 μm or more, or 120 μm or more. Also, the fixing target includes a backside member having a thickness of 1,500 μm or less, or 800 μm or less.

### EXAMPLES

The present invention is more specifically described below by referring to Examples and Comparative Examples, but the present invention is not intended to be limited to these Examples. Incidentally, in the description below, unless otherwise indicated, “parts” and “%” are on the weight basis.

### <Evaluation Methods>

### [Light Transmittance]

The light transmittance in the wavelength range of 380 nm to 2,500 nm in the pressure-sensitive adhesive sheets of Examples and Comparative Examples was determined by measuring the absorption spectrum by means of a spectrophotometer (Spectrophotometer Model U-4100, manufactured by Hitachi High-Technologies Corporation).

### [Light Transmittance Change Amount]

From the light transmittance in the wavelength range of 600 to 800 nm in the pressure-sensitive adhesive sheets of Examples and Comparative Examples, the light transmittance change amount was calculated based on the following formula:

light transmittance change amount (%/nm)=(light transmittance at wavelength of 800 nm−light transmittance at wavelength of 600 nm)/200.

### [180° Peel Adhesion]

In the pressure-sensitive adhesive sheets of Examples and Comparative Examples, the pressure-sensitive adhesive force was evaluated by performing a peel adhesion test in conformity with JIS Z 0237:2009. More specifically, in an environment at 23° C. and 50% RH, a PET film having a thickness of 50 μm was attached to one pressure-sensitive adhesive surface of a double-sided pressure-sensitive adhesive sheet to serve as a backing, and the lined sheet was cut to a width of 25 mm to prepare a measurement sample. Another pressure-sensitive adhesive surface of the measurement sample was attached to a SUS304BA plate serving as an adherend over an adhesion area of 25 mm in width and 100 mm in length by reciprocating a 2-kg roller once. The measurement sample thus attached to the adherend was left standing for 5 days in an environment of 65° C. and 90% RT. Thereafter, the force (N/25 mm) when peeling the measurement sample from the adherend at a peel angle of 180° and a tensile speed of 300 mm/min was measured.

### Example 1

### (Preparation of Pressure-Sensitive Adhesive Composition)

Into a reaction vessel equipped with a stirrer, a thermometer, a nitrogen inlet tube, a reflux condenser and a dropping funnel, 95 parts of n-butyl acrylate (BA) and 5 parts of acrylic acid (AA) as monomer components were charged, followed by stirring for 2 hours while introducing nitrogen gas. After removing oxygen in the polymerization system as above, 0.2 parts of 2,2′-azobisisobutyronitrile (AIBN) as the polymerization initiator was added, and solution polymerization was performed at 60° C. for 8 hours to obtain a solution of an acrylic polymer. Mw of this acrylic polymer was about 70×10⁴.

To the acrylic polymer solution, relative to 100 parts of the acrylic polymer contained in the solution, 0.4 parts of 1,2,3-benzotriazole (trade name: “BT-120”, produced by Johoku Chemical Co., Ltd.), 2 parts of a pigment (pigment species, “PG (Pigment Green)-7”), 20 parts of a terpene phenolic resin (trade name: “YS POLYSTAR T-115”, softening point: about 115° C., hydroxyl value: from 30 to 60 mg KOH/g, produced by Yasuhara Chemical Co., Ltd.) as a tackifying resin, and as crosslinking agents, 3 parts of an isocyanate-based crosslinking agent (trade name: “CORONATE L”, a 75% ethyl acetate solution of a trimethylolpropane/tolylene diisocyanate trimer adduct, produced by Tosoh Corporation) and 0.01 parts of an epoxy-based crosslinking agent (trade name: “TETRAD-C”, 1,3-bis(N,N-diglycidylaminomethyl)cyclohexane, produced by Mitsubishi Gas Chemical Co., Inc.) were added, followed by stirring and mixing to prepare a pressure-sensitive adhesive composition.

### (Production of Pressure-Sensitive Adhesive Sheet)

One sheet of a polyester release film (trade name: “DIAFOIL MRF”, thickness: 38 μm or thickness: 75 μm, produced by Mitsubishi Polyester Film Inc.) with one surface being release-treated to form a release surface was prepared as a release liner for each side. To the release surface of each of these release liners, the pressure-sensitive adhesive composition above was applied at a dry thickness of 35 μm and dried at 100° C. for 2 minutes. A pressure-sensitive adhesive layer was thus formed on each of the release surfaces of the two release liners. In this way, a 35 μm-thick substrateless double-sided pressure-sensitive adhesive sheet of which both surfaces are protected by the two sheets of a polyester release liner was obtained.

### Example 2

In this example, a substrateless double-sided pressure-sensitive adhesive sheet according to this example was produced in the same manner as in the production of the pressure-sensitive adhesive sheet according to Example 1 except that 2 parts of pigment species “PR-177” was used as the pigment.

### Example 3

In this example, a substrateless double-sided pressure-sensitive adhesive sheet according to this example was produced in the same manner as in the production of the pressure-sensitive adhesive sheet according to Example 1 except that 1 part of pigment species “PV-23” and 1 part of pigment species “PY-74” were used as the pigment.

### Example 4

In this example, a substrateless double-sided pressure-sensitive adhesive sheet according to this example was produced in the same manner as in the production of the pressure-sensitive adhesive sheet according to Example 1 except that 1 part of pigment species “PV-23” and 1 part of pigment species “PY-138” were used as the pigment.

### Example 5

In this example, a substrateless double-sided pressure-sensitive adhesive sheet according to this example was produced in the same manner as in the production of the pressure-sensitive adhesive sheet according to Example 1 except that 1 part of pigment species “PV-23” and 1 part of pigment species “PY-150” were used as the pigment.

### Example 6

In this example, a substrateless double-sided pressure-sensitive adhesive sheet according to this example was produced in the same manner as in the production of the pressure-sensitive adhesive sheet according to Example 1 except that 1.5 parts of pigment species “PV-23” and 1.5 parts of pigment species “PY-150” were used as the pigment.

### Example 7

In this example, a substrateless double-sided pressure-sensitive adhesive sheet according to this example was produced in the same manner as in the production of the pressure-sensitive adhesive sheet according to Example 1 except that 0.4 parts of pigment species “PR-177” and 1.6 parts of pigment species “PB-15:6” were used as the pigment.

### Example 8

The pressure-sensitive adhesive composition was prepared in the same manner as in Example 1 except that 2 parts of pigment species “PV-23” and 2 parts of pigment species “PY-150” were used as the pigment.

With regard to the pressure-sensitive adhesive sheet, one sheet of a polyester release film (trade name: “DIAFOIL MRF”, thickness: 38 μm or thickness: 75 μm, produced by Mitsubishi Polyester Film Inc.) with one surface being release-treated to form a release surface was prepared as a release liner for each side. To the release surface of each of these release liners, the pressure-sensitive adhesive composition above was applied at a dry thickness of 13 μm and dried at 100° C. for 2 minutes. A pressure-sensitive adhesive layer was thus formed on each of the release surfaces of the two release liners.

As the supporting substrate, a PET film having a thickness of 5 μm (trade name, “LUMIRROR S10”, produced by Toray Industries, Inc.) was used. The pressure-sensitive adhesive layers formed on the two release liners were bonded respectively to the first surface and second surface of the supporting substrate to produce a substrate-attached double-sided pressure-sensitive adhesive sheet according to this example (transfer method). The release liners were left as they were on the pressure-sensitive adhesive layers and used for the protection of the surfaces (adhesive surfaces) of the pressure-sensitive adhesive layers.

### Example 9

The pressure-sensitive adhesive composition was prepared in the same manner as in Example 8 except that 1.5 parts of pigment species “PV-23” and 1.5 parts of pigment species “PY-150” were used as the pigment.

The pressure-sensitive adhesive sheet was produced in the same manner as in Example 8 except that the pressure-sensitive adhesive composition was applied to the release surface of the release liner at a dry thickness of 17 μm and the thickness of the supporting substrate was changed to 16 μm.

### Example 10

The pressure-sensitive adhesive composition was prepared in the same manner as in Example 8 except that 1 part of pigment species “PV-23” and 1 part of pigment species “PY-150” were used as the pigment.

The pressure-sensitive adhesive sheet was produced in the same manner as in Example 8 except that the pressure-sensitive adhesive composition was applied to the release surface of the release liner at a dry thickness of 28 μm and the thickness of the supporting substrate was changed to 25 μm.

### Example 11

The pressure-sensitive adhesive composition was prepared in the same manner as in Example 8 except that 0.9 parts of pigment species “PV-23” and 0.9 parts of pigment species “PY-150” were used as the pigment.

The pressure-sensitive adhesive sheet was produced in the same manner as in Example 8 except that the pressure-sensitive adhesive composition was applied to the release surface of the release liner at a dry thickness of 38 μm and the thickness of the supporting substrate was changed to 25 μm.

### Example 12

The pressure-sensitive adhesive composition was prepared in the same manner as in Example 1 except that 1.15 parts of pigment species “PV-23” and 1.15 parts of pigment species “PY-150” were used as the pigment.

The pressure-sensitive adhesive sheet was produced in the same manner as in Example 1 except that the pressure-sensitive adhesive composition was applied to the release surface of the release liner at a dry thickness of 50 μm.

### Example 13

The pressure-sensitive adhesive composition was prepared in the same manner as in Example 1 except that 0.75 parts of pigment species “PV-23” and 0.75 parts of pigment species “PY-150” were used as the pigment.

The pressure-sensitive adhesive sheet was produced in the same manner as in Example 1 except that the pressure-sensitive adhesive composition was applied to the release surface of the release liner at a dry thickness of 100 μm.

### Comparative Example 1

A substrateless double-sided pressure-sensitive adhesive sheet according to this example was produced in the same manner as in the production of the pressure-sensitive adhesive sheet according to Example 1 except that in the pressure-sensitive adhesive composition, 0.7 parts of “ATDN101 BLACK” (produced by Dainichiseika Color & Chemicals Mfg. Co., Ltd.) was used as the pigment.

### Comparative Example 2

A substrateless double-sided pressure-sensitive adhesive sheet according to this example was produced in the same manner as in the production of the pressure-sensitive adhesive sheet according to Example 1 except that in the pressure-sensitive adhesive composition, 2 parts of “ATDN101 BLACK” (produced by Dainichiseika Color & Chemicals Mfg. Co., Ltd.) was used as the pigment.

Out of measurement results of the light transmittance in the wavelength range of 380 to 2,500 nm, the light transmittances at wavelengths of 380 nm, 600 nm, 800 nm and 2,000 nm are shown in Table 1. With regard to Examples 1, 2, 6 and 7 and Comparative Example 2, FIG. 4 illustrates light transmittance spectra in the wavelength range of 380 to 2,500 nm. In addition, the measurement results of light transmittance change amount in the wavelength region of 600 to 800 nm and 180° peel adhesion are also shown in Table 1.

Note that in Table 1, “-” indicates that the material concerned is not contained or not measured.

TABLE 1

| | | Example 1 | Example 2 | Example 3 | Example 4 | Example 5 | Example 6 | Example 7 | Example 8 |
|---|---|---|---|---|---|---|---|---|---|
| Total thickness of tape | μm | 35 | 35 | 35 | 35 | 35 | 35 | 35 | 30 |
| First PSA layer | μm | 35 | 35 | 35 | 35 | 35 | 35 | 35 | 13 |
| Substrate film | μm | — | — | — | — | — | — | — | transparent |
| | | | | | | | | | PET, 5 μm |
| Second PSA layer | μm | — | — | — | — | — | — | — | 13 |
| Pigment | parts | PG-7 | PR-177 | PV-23/PY- | PV-23/PY- | PV-23/PY- | PV-23/PY- | PR-177/PB- | PV-23/PY- |
| | | 2 parts | 2 parts | 74 = 1/1 | 138 = 1/1 | 150 = 1/1 | 150 = 1/1 | 15:6 = 1/4 | 150 = 1/1 |
| | | | | 2 parts | 2 parts | 2 parts | 3 parts | 2 parts | 4 parts |
| Average particle diameter of | nm | — | — | — | — | — | 187 | — | 187 |
| pigment | | | | | | | | | |
| Transmittance @2000 nm | % | 87.3 | 79.0 | 88.7 | 90.2 | 92.0 | 84.7 | 84.4 | 85.7 |
| Transmittance @800 nm | % | 69.8 | 71.1 | 70.2 | 75.3 | 84.6 | 73.7 | 69.5 | 70.4 |
| Transmittance @600 nm | % | 0.02 | 11 | 2.46 | 1.43 | 11.94 | 1.42 | 0.89 | 5.6 |
| Transmittance @380 nm | % | 23.4 | 10.8 | 1.4 | 0.5 | 6.3 | 0.4 | 5.3 | 6.1 |
| Transmittance change amount | %/nm | 0.35 | 0.30 | 0.34 | 0.37 | 0.36 | 0.36 | 0.34 | 0.32 |
| (600 to 800 nm) | | | | | | | | | |
| Pressure-sensitive adhesive force | N/25 | 8.0 | 7.3 | 17.6 | 17.0 | 18.6 | 16.8 | 14.5 | 9.2 |
| | mm | | | | | | | | |

| | | | | | | | Comparative | Comparative |
|---|---|---|---|---|---|---|---|---|
| | | Example 9 | Example 10 | Example 11 | Example 12 | Example 13 | Example 1 | Example 2 |
| Total thickness of tape | μm | 50 | 80 | 100 | 50 | 100 | 35 | 35 |
| First PSA layer | μm | 17 | 28 | 38 | 50 | 100 | 35 | 35 |
| Substrate film | μm | transparent | transparent | transparent | — | — | — | — |
| | | PET, 16 μm | PET, 25 μm | PET, 25 μm | | | | |
| Second PSA layer | μm | 17 | 28 | 38 | — | — | — | — |
| Pigment | parts | PV-23/PY- | PV-23/PY- | PV-23/PY- | PV-23/PY- | PV-23/PY- | ATDN101 | ATDN101 |
| | | 150 = 1/1 | 150 = 1/1 | 150 = 1/1 | 150 = 1/1 | 150 = 1/1 | 0.7 parts | 2 parts |
| | | 3 parts | 2 parts | 1.8 parts | 2.3 parts | 1.5 parts | | |
| Average particle diameter of | nm | 187 | 187 | 187 | 187 | 187 | 429 | 429 |
| pigment | | | | | | | | |
| Transmittance @2000 nm | % | 83.2 | 81.0 | 80.3 | 79.4 | 76.5 | 62.8 | 9.6 |
| Transmittance @800 nm | % | 68.1 | 65.4 | 63.9 | 62.6 | 61.6 | 47.7 | 1.3 |
| Transmittance @600 nm | % | 2.9 | 3.4 | 4.0 | 3.5 | 3.1 | 40.8 | 0.5 |
| Transmittance @380 nm | % | 4.8 | 4.1 | 5.2 | 5.1 | 4.2 | 35.7 | 0.3 |
| Transmittance change amount | %/nm | 0.33 | 0.31 | 0.30 | 0.29 | 0.28 | 0.03 | 0.00 |
| (600-800 nm) | | | | | | | | |
| Pressure-sensitive adhesive force | N/25 | 12.1 | 15.6 | 17.1 | 20.3 | 24.6 | 20.0 | 19.0 |
| | mm | | | | | | | |

As shown in Table 1 and FIG. 4, in pressure-sensitive adhesive sheets of Examples 1, 2, 6 and 7, the light transmittance was 25% or less over the entire wavelength range of 380 to 600 nm and the light transmittance was 60% or more over the entire wavelength range of 800 to 2,000 nm. Incidentally, although not illustrated in FIG. 4, it was confirmed that the light transmittance is 60% or more as well in the wavelength range of 2,000 to 2,500 nm.

In addition, with regard to Examples 3 to 5 and 8 to 13, although not illustrated in FIG. 4, it was also confirmed that the light transmittance is 25% or less over the entire wavelength range of 380 to 600 nm and the light transmittance is 60% or more over the entire wavelength range of 800 to 2,500 nm.

Furthermore, in the pressure-sensitive adhesive sheets of Examples 1 to 13, a light transmittance change amount of 0.1%/nm or more in the wavelength region of 600 to 800 nm was realized. Also, they showed a high value in the pressure-sensitive adhesive force.

On the other hand, in Comparative Examples 1 and 2, a light transmittance of 60% or more in the wavelength range of 800 to 2,500 nm could not be realized. Furthermore, a light transmittance change amount of 0.1%/nm or more in the wavelength region of 600 to 800 nm could not be realized either.

In this way, a pressure-sensitive adhesive sheet having wavelength selectivity of blocking light in a wide visible range and transmitting infrared light can be realized by selecting a pigment having the predetermined light transmittance from various pigments, combining two or more pigments, and furthermore, adjusting the contents or content ratio of various pigments.

In the foregoing pages, various embodiments have been described by referring to the drawings, but the present invention is of course not limited to these examples. It is apparent that one skilled in the art can conceive various modifications or alterations within the scope as set forth in the claims, and these are naturally understood to also belong to the technical scope of the present invention. Furthermore, respective constitutional elements in the embodiments above may be arbitrarily combined without departing from the gist of the present invention.

This application is based on Japanese Patent Application (Japanese Patent Application No. 2020-052937) filed on Mar. 24, 2020, the contents of which are incorporated in this application by way of reference.

### REFERENCE SIGNS LIST

1, 2, 3: Pressure-sensitive adhesive sheet
11, 21, 31a, 31b: Pressure-sensitive adhesive layer
22, 32: Substrate

1. A pressure-sensitive adhesive sheet comprising a pressure-sensitive adhesive layer containing a base polymer and a pigment, wherein
the light transmittance in the wavelength range of 380 to 600 nm is 25% or less, the light transmittance in the wavelength range of 800 to 2,500 nm is 60% or more, and
the light transmittance change amount in the wavelength region of 600 to 800 nm, represented by the following formula, is 0.1%/nm or more:
light transmittance change amount (%/nm)=(light transmittance at wavelength of 800 nm−light transmittance at wavelength of 600 nm)/200.

2. The pressure-sensitive adhesive sheet according to claim 1, wherein
the average particle dimeter of the pigment is 250 nm or less.

3. The pressure-sensitive adhesive sheet according to claim 1, wherein the pressure-sensitive adhesive layer contains an acrylic polymer as the base polymer.

4. The pressure-sensitive adhesive sheet according to claim 1, wherein the pressure-sensitive adhesive layer contains from 0.5 to 20 parts by mass of the pigment per 100 parts by mass of the base polymer.

5. The pressure-sensitive adhesive sheet according to claim 1, wherein the thickness is from 10 to 200 μm.

6. The pressure-sensitive adhesive sheet according to claim 1, wherein the 180° peel adhesion (N/25 mm) to an SUS304BA plate is 3 N/25 mm or more.

7. The pressure-sensitive adhesive sheet according to claim 1, which has a substrate.

8. The pressure-sensitive adhesive sheet according to claim 1, which does not have a substrate.

9. The pressure-sensitive adhesive sheet according to claim 1, which is used in an electronic device comprising a pressure-sensitive sensor.

10. The pressure-sensitive adhesive sheet according to claim 9, which is used in a mobile electronic device comprising a pressure-sensitive sensor so as to fix the pressure-sensitive sensor to other members.

11. A mobile electronic device, wherein the pressure-sensitive adhesive sheet according to claim 1 is used.
